(19) United States
(12) Patent Application Publication
(10) Pub. No.: US 2004/0213237 A1
(43) Pub. Date: Oct. 28, 2004

(54) Network authentication apparatus and network authentication system

(76) Inventors: Toshikazu Yasue, Chigasaki (JP); Tatsuya Watanuki, Ebina (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/802,948

(22) Filed: Mar. 18, 2004

(30) Foreign Application Priority Data
Mar. 19, 2003 (JP) 2003-075865
Jun. 29, 2000 (JP) 2000-195706

(51) Int. Cl. H04L 12/56; H04L 12/28; G06F 15/173

(52) U.S. Cl. 370/392; 709/238

(57) ABSTRACT

A network authentication apparatus has a network interface unit connected with a network and transmitting/receiving a packet, and a packet relay unit for relaying a received packet in accordance with a destination address of the received packet. It further includes a filtering processing unit for judging whether to relay the received packet to the packet relay unit or discard the packet in accordance with two or more of a destination MAC address, destination IPv6 address, source MAC address, source IPv6 address and source IPv6 interface ID contained in the received packet.

### CROSS-REFERENCE TO RELATED APPLICATION

This application relates to U.S. patent application Ser. No. 09/893,004 filed on Jun. 28, 2001, based on Japanese Patent Application Number 2000-195706 filed on Jun. 29, 2000, which is assigned to the present assignee. The content of the application is incorporated herein by reference.

### BACKGROUND OF THE INVENTION

This invention relates to a network authentication apparatus and a network authentication system. Particularly, it relates to a network authentication apparatus that relays packets from a terminal device authorized to access the network, and such a network authentication system.

With the development of various types of information devices and communication devices, use of networks has become increasingly popular. As networks have been increasingly used, the need for an information security technique for limiting use of networks is recognized in order to secure reliability of information existing in the networks. For example, there is a possibility that a server connected to a network constructed by an arbitrary user may be accessed by an unauthorized user existing outside of the network or by a user who exists in the network but is not authorized to use the server. As measures to prevent such unauthorized accesses, user authentication by user ID and password, and packet filtering using a communication device such as a router have been known.

As packet filtering, MAC (media access control) filtering using an L2 (layer 2) switch (for example, LAN switch) for relaying packets (frames) within the same subnet is known. Also IP filtering with a router for routing packets between different subnets is known. Such techniques are disclosed, for example, in JP-A-2002-84306.

Moreover, a multilayer switch capable of performing MAC filtering and IP filtering has been proposed. FIG. 28 shows a structural view of a multilayer switch. As shown in FIG. 28, a multilayer switch has, for example, an L2 switch unit 10, a router unit 20, and a layer judging unit 30. A MAC address processing unit 11 of the L2 switch unit 10 refers to a MAC address filtering table 12 and filters a packet on the basis of MAC address (physical address). An IP address processing unit 21 of the router unit 20 refers to an IP address filtering table 22 and filters a packet on the basis of IP address. In some cases, the router unit 20 performs routing processing such as elimination of a MAC header or change of the number of hops. The layer judging unit 30 relays a packet to either the L2 switch unit 10 or the router unit 20 on the basis of a condition such as whether the destination IP subnet of the received packet is identical to the subnet of the input port, or that the destination port and the input port belong to the same VLAN (virtual LAN). As shown in FIG. 28, the multilayer switch performs filtering using only one of MAC address and IP address on the basis of the result of judgment by the layer judging unit 30.

As the Wide-Area Ethernet (trademark registered) service has started, it is possible to construct a wide-area VPN (virtual private network) that connects a corporation with a home (for example, SOHO or small office home office) using this service. However, while Wide-Area Ethernet (trademark registered) can be easily used, it has a problem of poor security strength.

Moreover, with the popularization of leased circuit type broadband such as ADSL (asymmetric digital subscriber line) and cable television, the demand for construction of remote offices has been increasing. The construction of remote offices is aimed at constructing a corporate intranet connecting the head office of a corporation and its branch office or a home (SOHO) at a low cost using an Internet VPN, which is a combination of the Internet and IPsec (IP security protocol). For corporate intranet, each office has its unique policies, and generally, only specific users from other offices of the same corporation are authorized to access the intranet. Therefore, security measures and security system based on the unique policies are necessary. However, in the Internet VPN, since VPN is formed between networks via a router, authentication and filtering based on MAC address cannot be carried out and filtering or the like based on IP address is carried out.

### SUMMARY OF THE INVENTION

In the case of the Internet using conventional IPv4 (Internet Protocol version 4), if the terminal device of a certain user moves, the terminal device newly receives distribution of an IP address from a DHCP (dynamic host configuration protocol) server, at the destination. Therefore, the IP address of the terminal device changes every time it moves. In some cases, the IP address cannot be used as a parameter of user authentication and filtering. That is, in a system where user authentication and filtering are performed using the conventional IPv4 address, it is difficult to secure both mobility and security. There is also a problem of poor security against an intruder spoofing as a device having the same IPv4 address.

In a network using a router such as an Internet VPN, user authentication using information proper to the terminal device used by the user, and packet filtering cannot be carried out in some cases. That is, when a packet is relayed by the router, the MAC address of the terminal device included in the packet is replaced by the MAC address of the router. Therefore, user authentication or the like using the MAC address of the terminal device cannot be carried out for the packet relayed by the router.

In view of the foregoing status of the art, it is an object of this invention to provide a high-security network authentication apparatus and network authentication system for rejecting access from a terminal device that is not authorized to access the network and access from a spoofing intruder.

It is another object of this invention to provide a network authentication apparatus that performs user authentication and packet filtering with high security strength, utilizing an interface ID part of IPv6 address.

It is still another object of this invention to provide a network authentication apparatus and a network authentication system that have higher strength than filtering by the conventional IPv4 address and also have high security to movement of a terminal device.

According to this invention, there is provided a network authentication apparatus having a filtering processing unit for judging whether to relay a received packet to a packet relay unit or discard the received packet, on the basis of two or more of a destination MADC address, destination IPv6 address, source MAC address, source IPv6 address and source IPv6 interface ID included in the received packet.

According to this invention, there is also provided a network authentication system including an authentication server for executing authentication of an information terminal device on the basis of predetermined information, and a network node apparatus for judging whether to relay or discard a received packet on the basis of two or more of a destination MADC address, destination IPv6 address, source MAC address, source IPv6 address and source IPv6 interface ID included in the received packet.

### BRIEF DESCRIPTION OF THE DRAWINGS

FIG. 1 shows a structural view of a network authentication system.

FIG. 2 shows a structural view of a network node.

FIG. 3 shows a structural view of a filtering processing unit.

FIG. 4 shows a structural view of an authentication server.

FIG. 5 shows a structural view of a network node.

FIG. 6 shows a structural view of an authentication processing unit.

FIG. 7 shows a format of IPv6 address.

FIG. 8 shows an exemplary structure (1) of a filtering table.

FIG. 9 shows an exemplary structure (2) of the filtering table.

FIG. 10 shows an exemplary structure (1) of an address table.

FIG. 11 shows a functional structural view of a packet processing unit.

FIG. 12 shows a structural view of a filtering processing unit.

FIGS. 13A and 13B show structural views of a MAC address filtering table and an IPv6 address filtering table.

FIG. 14 shows a structural view in the case where the network authentication system is applied to a wide-area L2 network.

FIG. 15 shows a structural view of the address table.

FIG. 16 shows a sequence the case where a user terminal accesses a file server.

FIG. 17 shows a structural view of the filtering table.

FIG. 18 shows a structural view in the case where the network authentication system is applied to a private data center.

FIGS. 19A and 19B show an exemplary structure (3) of the filtering table.

FIGS. 20A and 20B show an exemplary structure (2) of the address table.

FIG. 21 shows a sequence in the case where a user terminal accesses a file server.

FIG. 22 shows a structural view in the case where the network authentication system is applied to an Internet VPN.

FIG. 23 shows a structural view of a network node.

FIG. 24 shows an exemplary structure of a key table.

FIGS. 25A and 25B show an exemplary structure (4) of the filtering table.

FIGS. 26A and 26B show an exemplary structure (3) of the address table.

FIG. 27 shows a sequence in the case where a user terminal accesses a file server.

FIG. 28 shows a structural view of a multilayer switch.

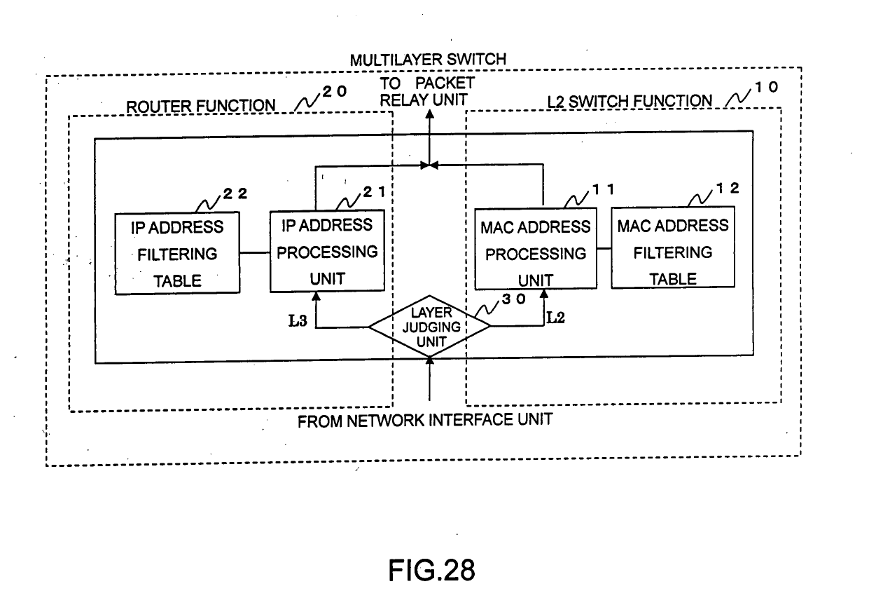

### DETAILED DESCRIPTION OF THE PREFERRED EMBODIMENTS

1. Network Authentication System

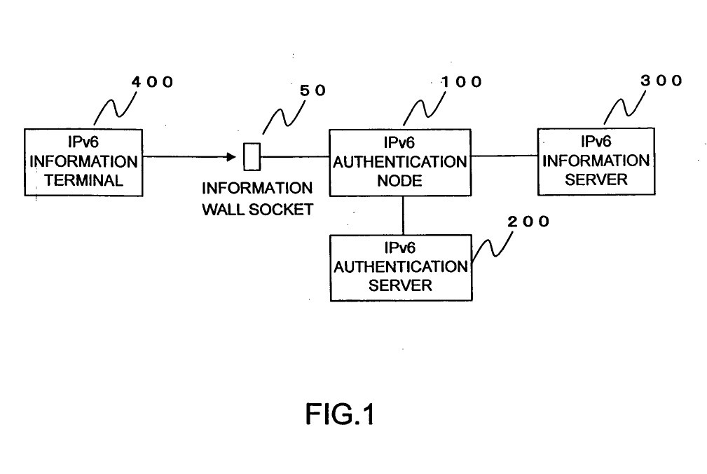

FIG. 1 shows a structural view of a network authentication system.

In FIG. 1, the network authentication system has an authentication node (network node) 100 capable of communicating on IPv6 (Internet Protocol version 6), an authentication server 200, an information server 300, and an information terminal device (user terminal) 400. For example, the user terminal 400 is connected to the network node 100 via an information wall socket 50.

The network node 100 checks whether each packet sent from the user terminal 400 is a packet from the user terminal 400 authenticated by the authentication server 200 or not, and relays or discards the packet accordingly. For example, a packet sent to the information server 300 from the user terminal 400 that is not user-authenticated is discarded by the network node 100.

The authentication server 200 performs user authentication in response to a request from the user terminal 400. As the user authentication is completed, the authentication server 200 notifies the network node 100 of the result of the authentication. Receiving this notification, the network node 100 relays a packet from the authenticated user terminal 400.

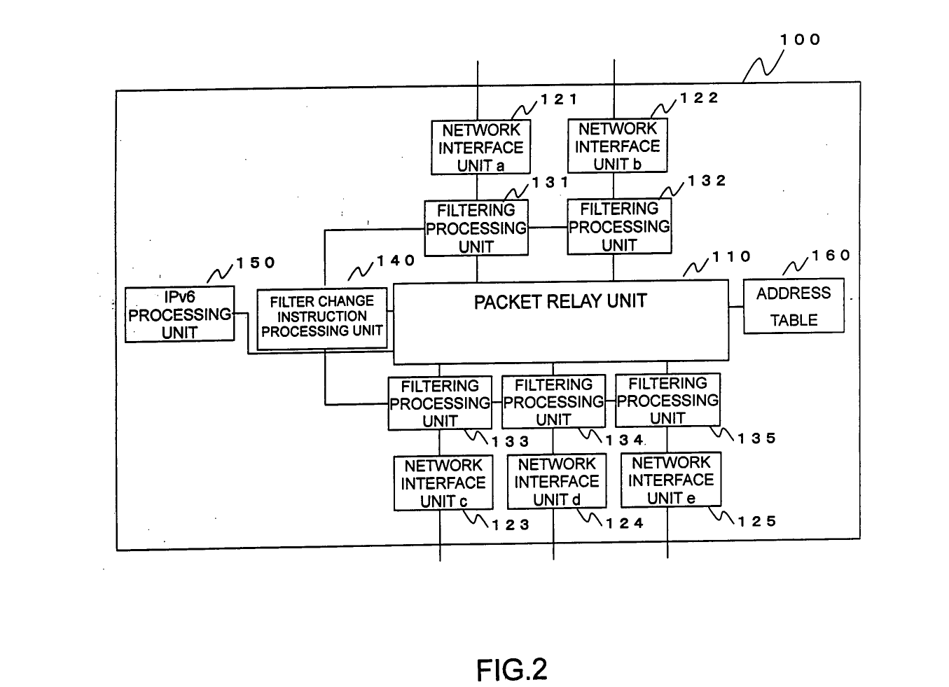

FIG. 2 shows an exemplary structural view of the network node 100. In FIG. 2, the network node 100 has, for example, a packet relay unit 110, network interface units a 121 to e 125, filtering processing units 131 to 135, a filter change instruction processing unit 140, an IPv6 processing unit 150, and an address table 160. The network authentication system can include a suitable number of network interface units and filtering processing units.

The network interface units a 121 to e 125 are connected to different terminal devices, servers or networks, respectively, and transmit and receive packets. When a packet is received, the packet relay unit 110 refers to the address table 160 on the basis of the destination of the packet and transmits the packet via the network interface units a 121 to e 125 indicated by the address table 160.

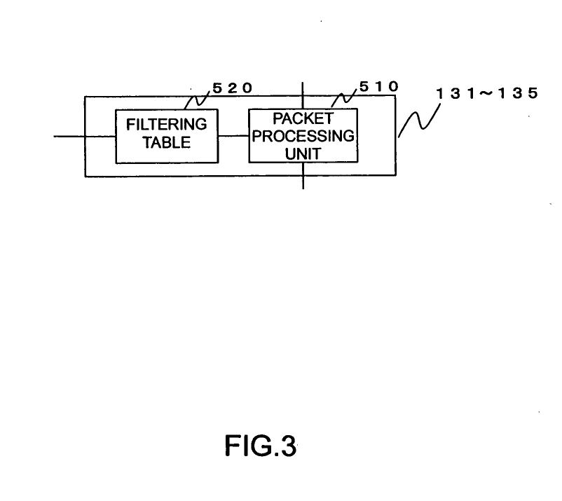

FIG. 3 shows a structural view of the filtering processing unit 131. Since the filtering processing units 131 to 135 have the same structure, FIG. 3 shows only the filtering processing unit 131. In FIG. 3, the filtering processing unit 131 has a packet processing unit 510 and a filtering table 520. The packet processing unit 510 receives a packet via the network interface unit a 121 connected thereto, and judges whether to “relay” or “discard” the packet on the basis of the content of the filtering table 520. If the packet processing unit 510 determines to “relay”, the packet processing unit 510 sends the received packet to the packet relay unit 110. On the other hand, if the packet processing unit 510 determines to “discard”, the packet processing unit 510 discards the packet.

In the filtering table 520, information for judging whether to relay or discard a packet is stored. For example, the destination MAC address, source MAC address and/or source IPv6 address and/or interface ID of the source IPv6 address (hereinafter referred to as IPv6 interface ID), and information indicating relay or discard of the packet are associated with each other and stored. The filtering table 520 is connected with the filter change instruction processing unit 140, and the content of the table is changed by the filter change instruction processing unit 140. For example, in an initial state, a filter table is constructed so as to discard packets except for packets addressed to the authentication server 200. Later, the content of the table is suitable changed so as to relay packets from a terminal device authenticated by the authentication server 200.

The filter change instruction processing unit 140 communicates with the authentication server 200 and receives a status change instruction for the filtering table 520 from the authentication server 200. The status change instruction includes, for example, the content of a target entry and an instruction to add/delete. As the filter change instruction processing unit 140 receives the status change instruction, the filter change processing unit 140 reflects the instruction on the filtering table 520.

The IPv6 processing unit 150 notifies the user terminal 400 of the network ID, using a router notification protocol (router advertisement). The IPv6 processing unit 150 periodically sends the network ID. When a router request protocol (router solicitation) is received from the user terminal 400, the IPv6 processing unit 150 similarly notifies the user terminal 400 of the network ID.

The network node 100 is, for example, a switch that operates on L2. Unlike a router, it does not perform routing processing such as change of the number of hops. As the switch that operates on L2 is provided with a filtering function based on MAC address and IPv6 address, a network node having a simple structure and high security strength can be provided.

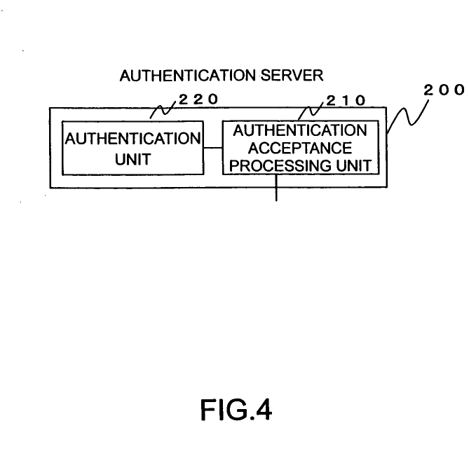

FIG. 4 shows a structural view of the authentication server 200. The authentication server 200 has an authentication acceptance processing unit 210 and an authentication unit 220 that actually performs user authentication. The authentication acceptance processing unit 210 is a unit for accepting a user authentication request from the user terminal 400. In web authentication, it is equivalent to a portal site. In the authentication unit 220, for example, a table in which user ID (user identifier), password, IPv6 interface ID and MAC address are associated with each other has been stored in advance as authentication data. By using IPv6 interface ID in addition to user ID and password, it is possible to prevent access through unauthorized use of the user ID and password. Moreover, authentication data for authentication by the IKE (Internet key exchange) protocol (for example, pre-shared key predetermined with a communication counterpart) may be stored in the authentication unit 220.

The authentication unit 220 can be used in combination with generally used authentication servers of RAIDUS (remote authentication dial in user service), LDAP (lightweight directory access protocol) and the like. Moreover, the authentication server 200 can be provided within the network node 100.

The information server 300 shown in FIG. 1 is a server that stores information to be provided to the user terminal 400. For example, it is a file server or a user terminal having a shared file, and it provides data in response to a request from the user terminal 400. The information server 300 may also be an arithmetic unit that performs arithmetic processing corresponding to a request from the user terminal 400.

The user terminal 400 is a terminal device capable of communicating on IPv6. For example, a personal computer using Windows (trademark registered) XP as its operating system can be used. The user terminal 400 is user-authenticated by the authentication server 200 via the information wall socket 50 and accesses the information server 300 in the network.

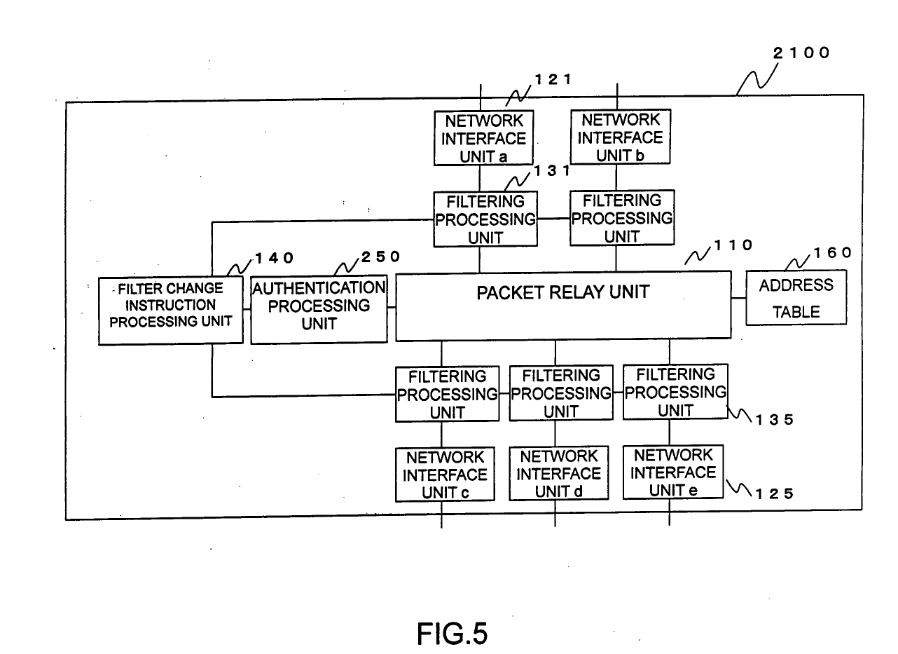

FIG. 5 shows another exemplary structure of the network node shown in FIG. 1.

A network node 2100 shown in FIG. 5 includes an authentication server function in addition to the structure of the network node 100 shown in FIG. 2. Specifically, the network node 2100 has a packet relay unit 110, network interface units a 121 to e 125, filtering processing units 131 to 135, a filter change instruction processing unit 140, an address table 160, and an authentication processing unit 250. The network node 2100 may further has an IPv6 processing unit 150.

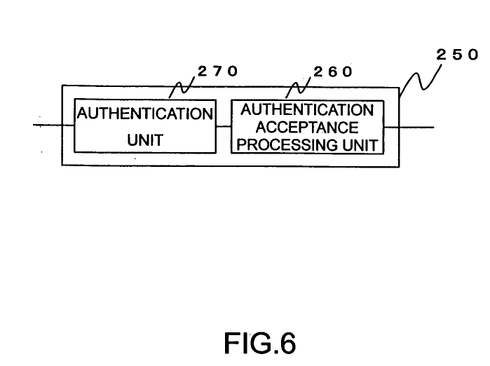

FIG. 6 shows a structural view of the authentication processing unit 250. In FIG. 6, the authentication processing unit 250 has an authentication acceptance processing unit 260 and an authentication unit 270. It is also possible to provide only the authentication acceptance processing unit 260 in the authentication processing unit 250. The authentication acceptance processing unit 260 and the authentication unit 270 have the same functions as the authentication acceptance processing unit 210 and the authentication unit 220 of the authentication server 200 shown in FIG. 4. The authentication processing unit 250 receives an authentication request packet form the packet relay unit 110 and performs authentication. After the authentication, the authentication processing unit 250 sends a status change instruction for the filtering table 520 to the filter change instruction processing unit 140. As the function of the authentication server 200 is provided within the network node 2100, a packet before authentication need not be relayed into the system and therefore the security strength improves.

IPv6 address will now be described.

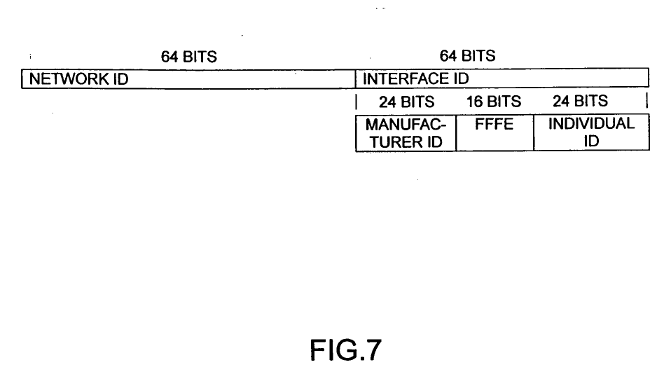

FIG. 7 shows a form at of IPv6 address. IPv6 address includes network ID of upper 64 bits and interface ID of lower 64 bits. The network ID is sent to the user terminal 400 by a communication device on the network, for example, a router. Such a communication device sends the network ID using the router notification protocol. The interface ID is ID proper to a device including manufacturer ID and individual ID. Therefore, the interface ID is invariant ID for each device even when the network to be connected is changed. “FFFE” in the interface. ID is inserted between the manufacturer ID and the individual ID in the case of preparing the 64-bit interface ID from 48-bit MAC address.

The user terminal 400 connected to the network acquires the network ID from the network node 100 (or a router existing in the network), using the router request protocol. The network node 100 notifies the user terminal 400 of the network ID using the router notification protocol, in accordance with a router request command from the user terminal 400 or periodically. Having acquired the network ID, the user terminal 400 automatically generates IPv6 address from the network ID and its own interface ID.

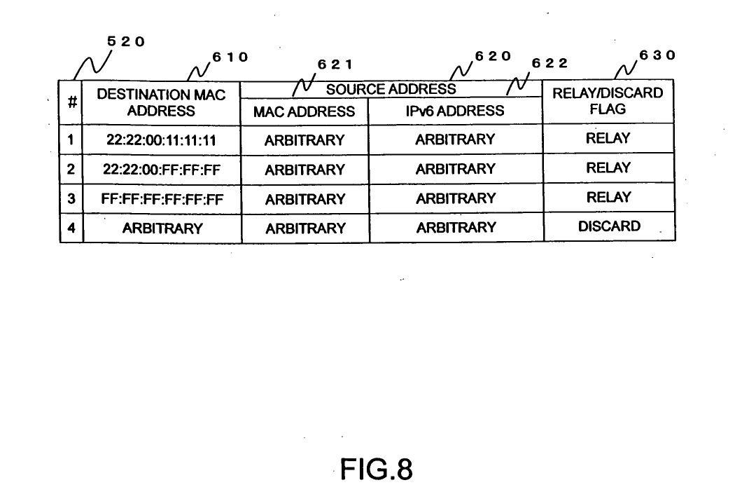

FIG. 8 shows an exemplary structure (1) of the filtering table 520. The filtering table 520 stores information for judging whether to relay or discard a packet. Each entry includes a destination address field 610, a source address field 620, and a relay/discard flag field 630. In the destination address field 610, destination MAC address or information representing “arbitrary” is registered. IPv6 address or the like may be used as the destination address. The source address field 620 includes a source MAC address field 621 and a source IPv6 address field 622, in which MAC address and IPv6 address or information representing “arbitrary” are registered, respectively. The notation of addresses in FIG. 8 use hexadecimal numbers, and 0 is compressed.

In the relay/discard flag field 630, a flag (information) is registered which indicates whether to relay or discard a received packet when the destination address and source address of the packet match with the contents of the destination address field and source address field. When a packet matches with information of plural entries, an entry close to the leading end of the table is applied to the packet. A packet that coincides with no entry is sent to the packet relay unit 110 by the packet processing unit 510.

The packet processing unit 510 can employ a system for separately (or in order) carrying out filtering by MAC address (MAC filtering) and filtering by IPv6 address (IPv6 filtering), that is, an independent filtering system. In the case of MAC filtering, the packet processing unit 510 use both the address in the destination address field 610 and the address in the source MAC address field 621 as AND conditions and judges “relay” or “discard” of a packet in accordance with the information of the relay/discard flag field 630. On the other hand, in the case of IPv6 filtering, the packet processing unit 510 use both the address in the destination address field 610 and the address in the source IPv6 address field 622 as AND conditions and judges “relay” or “discard” of a packet in accordance with the information of the relay/discard flag field 630. A MAC address filtering table having only MAC address registered in the source address field 620 and an IPv6 address filtering table having only IPv6 address registered in the source address field 620 may be separately stored in the filtering processing unit.

The packet processing unit 510 can also employ a system for filtering by MAC address and IPv6 address, that is, a batch filtering system. The packet processing unit 510 can use the three addresses in the destination address field 610, the source MAC address field 621 and the source IPv6 address field 622 as AND conditions and judge “relay” or “discard” of a packet in accordance with the information of the relay/discard flag field 630.

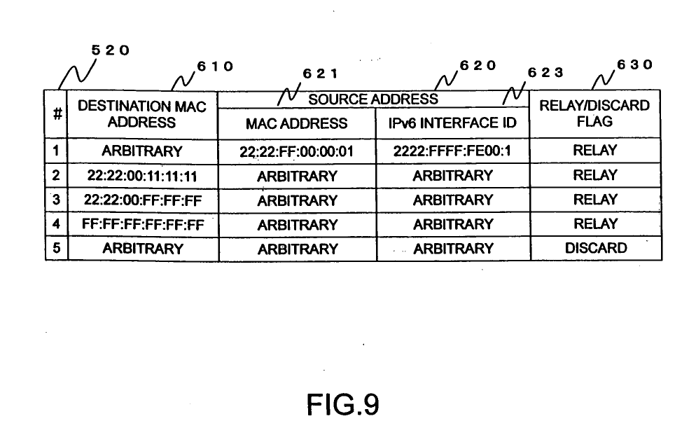

FIG. 9 shows an exemplary structure (2) of the filtering table 520. The entries in the filtering table 520 shown in FIG. 9 include a source IPv6 interface ID field 623 instead of the source IPv6 address field 622 in the filtering table 520 shown in FIG. 8. IPv6 interface ID or information representing “arbitrary” is registered in this source IPv6 interface ID field 623. The other fields are similar to the fields in the filtering table 520 shown in FIG. 8.

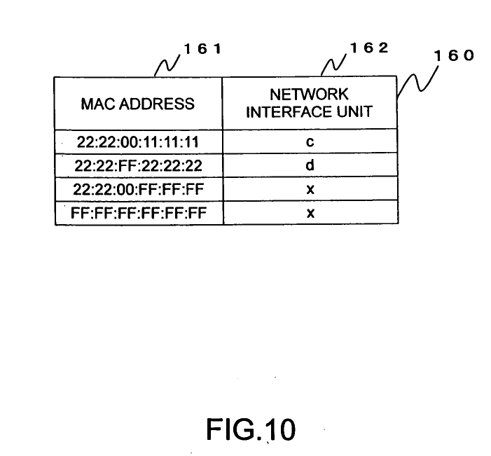

FIG. 10 is a view showing an exemplary structure (1) of the address table 160. The entries in the address table 160 include an address field 161 and a network interface unit field 162. For example, MAC address is stored in the address field 161 and the identifier of the network interface unit is stored in the interface unit field 162. Each entry in the address table 160 represents, for example, transmission of a packet to the destination MAC address of the packet from the corresponding network interface unit when relaying the packet. Suitable addresses such as IP address can also be registered in the address field 161.

Moreover, the address table 160 is constituted in such a manner that a packet of a router request command is relayed to the IPv6 processing unit 150. For example, an entry having the MAC address of the network node itself stored in the address field 161 and having “x” stored in the network interface unit field is registered in the address table 160. When “x” is acquired as the identifier of the network interface unit, the packet relay unit 110 relays the packet to the IPv6 processing unit 150. Also a packet having a broadcast address as its destination address is similarly relayed to the IPv6 processing unit 150. If a packet is not a router request command, the IPv6 processing unit 150 properly processes the packet.

The packet relay unit 110 may judge whether a received packet is a router request command or not, and may relay the packet to the IPv6 processing unit 150 if it is a router request command. If the packet is not a router request command, the packet relay unit 110 discards the packet in accordance with a predetermined policy or sends the packet from all the network interface units.

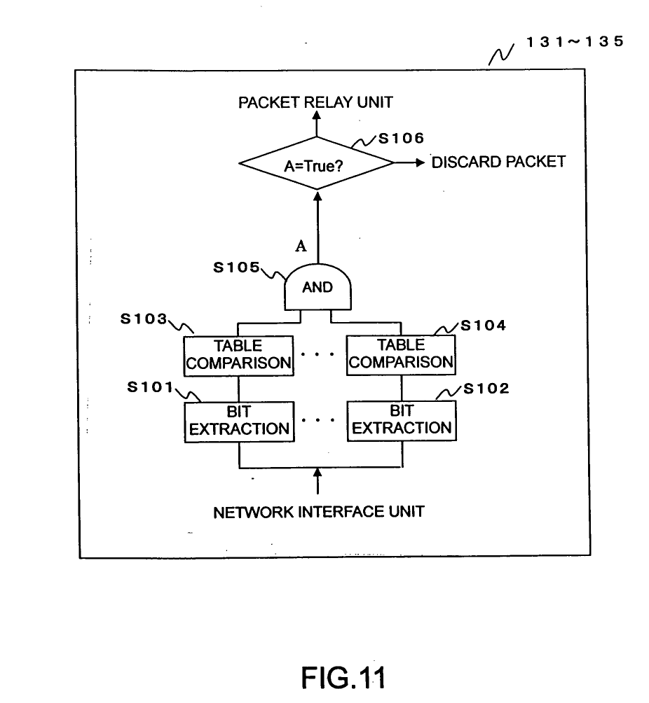

FIG. 11 shows a functional structural view of the packet processing unit 510.

When the packet processing unit 510 receives a packet from the network interface units a 121 to e 125, the packet processing unit 510 extracts an address to be a filtering target from the received packet (S101, S102). FIG. 11 shows that the packet processing unit 510 can simultaneously extract the destination MAC address, source MAC address and source IPv6 address from the received packet.

Next, the packet processing unit 510 refers to, for example, the filtering table 520 shown in FIG. 8, and compares each extracted address with each address registered in each field of the filtering table 520. If these addresses are coincident as a result of the comparison, the packet processing unit 510 acquires information representing relay or discard from the relay/discard flag field 630 of the entry where the address is registered (S103, S104) Next, the packet processing unit 510 calculates the logical sum of the information representing relay or discard, acquired for each address (S105). If all the information acquired for each address represents relay, the packet processing unit 510 sends the received packet to the packet relay unit 110. On the other hand, if even a part of the information represents discard, the packet processing unit 510 discards the received packet (S106) The packet processing unit 510 may compare each address extracted at steps S101 and S102 with the address registered in each field of the filtering table 520, and if there is an entry coincident with all the addresses, the packet processing unit 510 may acquire information representing relay or discard from the relay/discard flag field 630 of that entry. In this manner, the packet processing unit 510 simultaneously checks one or more addresses.

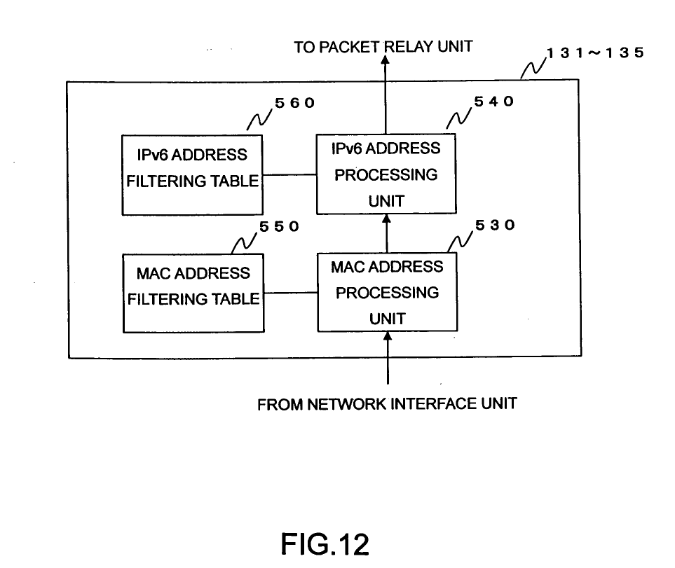

FIG. 12 shows another exemplary structural view of the filtering processing unit. Similar to FIG. 3, FIG. 12 shows only the filtering processing unit 131. The filtering processing unit 131 has a MAC address processing unit 530, an IPv6 address processing unit 540, a MAC address filtering table 550, and an IPv6 address filtering table 560. The filtering processing unit 131 shown in FIG. 12 executes MAC filtering by MAC address and IPv6 filtering by IPv6 address, stage by stage stages (in order).

In FIG. 12, when a packet is received from the network interface unit a 121, the MAC address processing unit 530 extracts the destination MAC address and source MAC address from the received packet and judges whether to “relay” or “discard” the packet with reference to the MAC address filtering table 550. If the MAC address processing unit 530 has determined to “relay”, it sends the received packet to the IPv6 address processing unit 540. On the other hand, if the MAC address processing unit 530 has determined to “discard” it discards the received packet.

As the IPv6 address processing unit 540 receives the packet from the MAC address processing unit 530, the IPv6 address processing unit 540 extracts the destination MAC address and source IPv6 address from the received packet and judges whether to “relay” or “discard” the packet with reference to the IPv6 address filtering table 560. If the IPv6 address processing unit 540 has determined to “relay”, it sends the received packet to the packet relay unit 110. If the IPv6 address processing unit 540 has determined to “discard”, it discards the received packet. The filtering processing unit 510 may execute IPv6 filtering first and then MAC filtering.

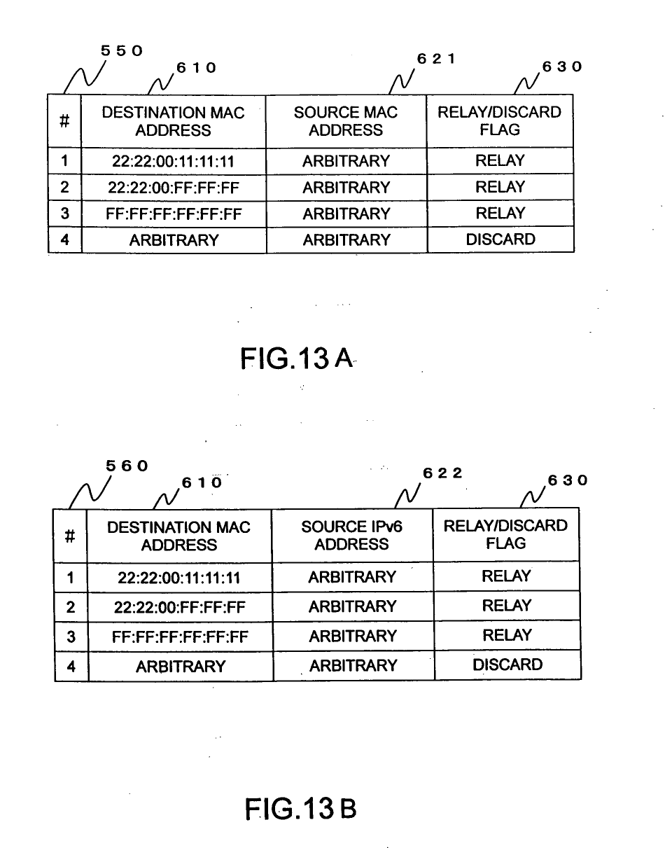

FIGS. 13A and 13B show structural views of the MAC address filtering table 550 and the IPv6 address filtering table 560. In short, the MAC address filtering table 550 and the IPv6 address filtering table 560 are formed by separating the source MAC address field 621 and the source IPv6 address field 622 of the filtering table 520 shown in FIG. 8 into different tables. The MAC address filtering table 550 shown in FIG. 13A includes the destination address field 610, the source MAC address field 621, and the relay/discard flag field 630. Also the IPv6 address filtering table 560 shown in FIG. 13B includes the destination address field 610 and the relay/discard flag field 630, and further includes the source IPv6 address field 622. IPv6 interface ID may be registered in the source IPv6 address field 622. IPv6 address may be registered in the destination address field 610.

The MAC address processing unit 530 and the IPv6 address processing unit 540 can perform filtering with reference to the filtering table 520 shown in FIG. 8 or FIG. 9. In this case, the MAC address processing unit 530 and the IPv6 address processing unit 540 judges whether to “relay” or “discard” a packet with reference to either MAC address or IPv6 address in the source address field 620.

2. Exemplary Application to Wide-Area L2 Network

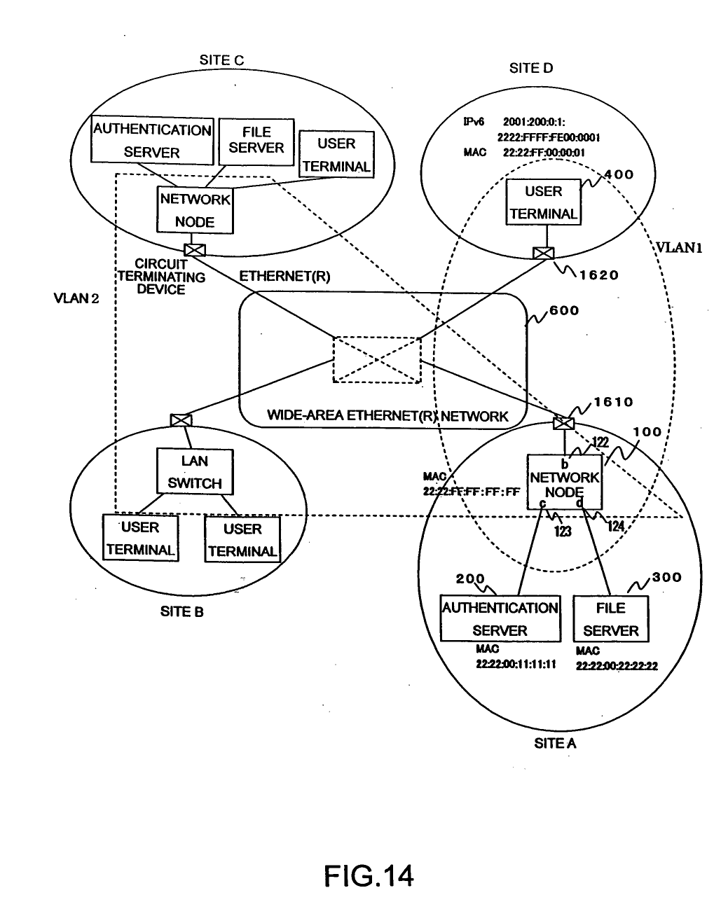

FIG. 14 shows a structural view in the case where the above-described network authentication system is applied to a wide-area L2 network.

FIG. 14 shows an example in which a corporation or the like constructs an in-house intranet, for example, using Wide-Area Ethernet (trademark registered) provided by a communication service provider. The wide-area L2 network service normally provides an L2 network constituted by a LAN switch (L2 switch).

In FIG. 14, sites A to D are connected via a wide-area L2 network 600 and the whole network operates like a private LAN. The site A has a network node 100, an authentication server 200, and a file server (information server) 300 which are connected to the wide-area L2 network 600 via a circuit terminating device 1610. The network node 100, the authentication server 200 and the file server (information server) 300 shown in FIG. 14 are equivalent to the authentication node 100, the authentication server 200 and the information server 300 shown in FIG. 1, respectively. Therefore, the network node 100 has the packet relay unit 110, the network interface units a 121 to e 125, the filtering processing units 131 to 135, the filter change instruction processing unit 140, the IPv6 processing unit 150, and the address table 160, as shown in FIG. 2. Each of the filtering processing units 131 to 135 has the MAC address processing unit 530 and the IPv6 address processing unit 540, as shown in FIG. 12. In this example, however, only the filtering table 520 is provided, which is different from FIG. 12. Each of the filtering processing units 131 to 135 may have the packet processing unit 510 and the filtering table 520, as shown in FIG. 3.

The site D has the user terminal 400 connected to the wide-area L2 network 600 via a circuit terminating device 1620. The sites B and C are connected to the wide-area L2 network 600 via their respective circuit terminating devices, and each of these sites has, for example, a network node, a LAN switch, a user terminal, an authentication server, a file server and the like.

On the site A, for example, the wide-area L2 network 600 is connected to the network interface unit b 122 of the network node 100, the authentication server 200 is connected to the network interface unit c 123, and the file server 300 is connected to the network interface unit d 124. The same IP subnet address is allocated to the side of the wide-area L2 network 600 and the side of the authentication server 200 and the file server 300, of the network node 100. Therefore, the system shown in FIG. 14 does not require a router used for connecting different IP subnets.

The user terminals on the site C and the site D can access the file server 300 on the site A via the wide-area L2 network 600. In this case, user authentication is carried out by each site. For example, the user terminal authenticated by the authentication server 200 on the site A can access all the servers within the site A.

In Wide-Area Ethernet (trademark registered), Ethernet (trademark registered) with VLAN-Tag packets are broadly used. The filtering processing units 131 to 135 can filter Ethernet (trademark registered) with VLAN-Tag packets as well as standard Ethernet (trademark registered) packets.

In the following description, it is assumed that MAC address of the network node 100 on the site A is “22:22:00:FF:FF:FF”, MAC address of the authentication server is “22:22:00:11:11:11”, and MAC address of the file server 300 is “22:22:00:22:22:22”. It is also assumed that MAC address of the user terminal 400 on the site D is “22:22:FF:00:00:01”.

It is assumed that the user terminal 400 on the site D can only access the file server 300 on the site A. The site A and the site D are set in advance as a VLAN (virtual LAN) 1, and the sites A, B and C are set in advance as a VLAN 2.

In the filtering processing unit 132 on the side of the wide-area L2 network 600 of the network node 100, for example, the filtering table 520 shown in FIG. 8 is stored. In this case, the filtering processing unit 132 relays only a packet addressed to a destination having the broadcast address “FF:FF:FF:FF:FF:FF”, the MAC address “22:22:00:FF:FF:FF” of the network node 100 itself or the MAC address “22:22:00:11:11:11” of the authentication server 200. Nothing has been registered in the tables of the filtering processing units 133 and 134 on the authentication server side and the file server side of the network node 100.

First, a case where the user terminal 400 on the site D generates IPv6 address will be described. When the user terminal 400 is connected to the wide-area L2 network 600, the user terminal 400 broadcasts a router request command to acquire network ID. At this point, the destination MAC address of a packet including the router request command is sent as broadcast address “FF:FF:FF:FF:FF:FF”. The broadcast router request command is transferred within the VLAN 1 and reaches the site A.

The filtering processing unit 132 of the network node 100 on the site A receives the packet including the router request command via the network interface unit b 122. The MAC address processing unit 530 of the filtering processing unit 132 refers to the filtering table 520 on the basis of the destination MAC address and source MAC address of the received packet and judges whether to relay or discard the packet. The entries having a destination MAC address in agreement with the broadcast address and having a source MAC address in agreement with the MAC address of the user terminal 400 are entries #3 and #4. The MAC address processing unit 530 refers to the entry #3, which is of a higher order in the table. The content of the relay/discard flag field 630 of the entry #3 represents “relay”. Therefore, the MAC address processing unit 530 sends the packet to the IPv6 address processing unit 540.

Having received the packet, the IPv6 address processing unit 540 refers to the filtering table 520 on the basis of the destination MAC address and source IPv6 address of the packet and judges whether to relay or discard the packet. The entries having a destination MAC address in agreement with the broadcast address and having a source IPv6 address coincident with the address of the user terminal 400 are the entries #3 and #4. The IPv6 address processing unit 540 refers to the entry #3, which is of a higher order. As described above, the content of the relay/discard flag field 630 of the entry #3 represents “relay”. Therefore, the IPv6 address processing unit 540 determines to relay the packet and sends the packet to the packet relay unit 110.

Having received the packet from the filtering processing unit 132, the packet relay unit 110 refers to the address table 160 and searches the address table 160 to find whether an entry having a coincident source MAC address exists or not. The entries shown in FIG. 10 are have been registered in the address table 160 in advance. If there is no corresponding entry in the address table 160, the packet relay unit 110 adds the source MAC address and the identifier of the network interface unit that received the router request command, to the address table 160.

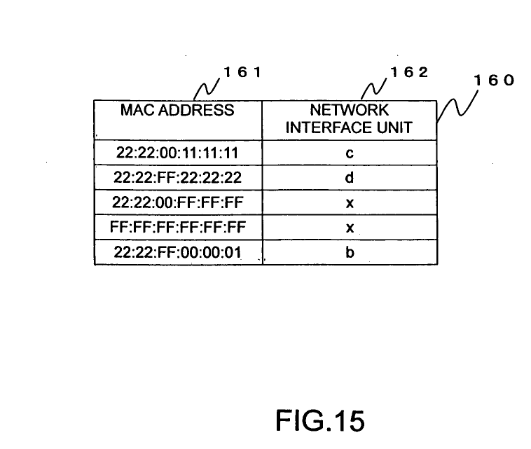

FIG. 15 shows a structural view of the address table 160 to which an entry of the user terminal 400 has been added. Since the address table 160 shown in FIG. 10 contains no entry having an address coincident with the MAC address of the user terminal 400, which is the source of transmission, the packet relay unit 110 adds an entry containing the MAC address of the user terminal 400 and the identifier “b” of the network interface unit b 122 that has received the packet.

Next, the packet relay unit 110 refers to the address table 160, then searches the address table 160 to find whether an entry having the coincident destination MAC address exists or not, and acquires the identifier of the network interface unit that relays the packet. Since the address table 160 contains an entry having broadcast address “FF:FF:FF:FF:FF:FF”, the packet relay unit 110 acquires “x” as the destination of relay. As the acquired destination of relay is “x”, the packet relay unit 110 transfers the received router request command to the IPv6 processing unit 150.

Having received the router request command, the IPv6 processing unit 150 generates a packet containing the network ID and addressed to the MAC address of the user terminal 400 as the destination, using a router notification command, and then sends the packet to the packet relay unit 110. The packet relay unit 110 refers to the address table 160 and searches the address table 160 for an entry having the coincident destination MAC address, as described above. Since the MAC address of the user terminal, which is the destination, has already been registered, as shown in FIG. 15, the packet relay unit 110 acquires the identifier “b” of the network interface unit as the destination of relay. In accordance with the acquired destination of relay “b”, the packet relay unit 110 sends the packet including the network ID to the user terminal 400 via the network interface unit b 122.

The user terminal 400 receives the network ID and prepares its own IPv6 address “2001:200:0:1:2222:FFFF:FE00:1” based on the received network ID and its own MAC address. After preparing the IPv6 address, the user terminal 400 performs user authentication to the network node 100 on the site A.

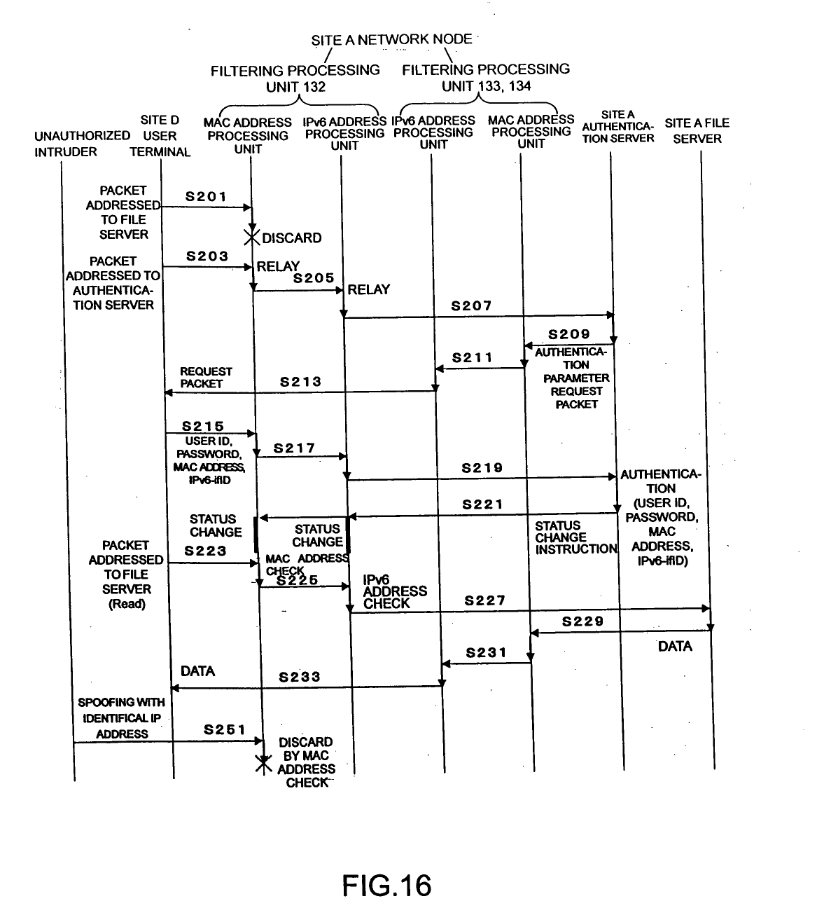

FIG. 16 shows a sequence in the case where the user terminal 400 on the site D accesses the file server 300 on the site A. First, a case where the user terminal 400 attempts to access the file server 300 without being user-authenticated will be described.

For example, it is assumed that a packet having the MAC address of the file server 300 as its destination MAC address is sent from the user terminal 400 on the site D (S201). The filtering processing unit 132 of the network node 100 receives this packet via the network interface unit b122. The MAC address processing unit 530 of the filtering processing unit 132 refers to the filtering table 520 shown in FIG. 8 on the basis of the destination MAC address and source MAC address of the received packet and judges whether to relay or discard the packet. Only the entry #4 is the entry having a destination MAC address coincident with the MAC address of the file server 300 and having a source MAC address coincident with the MAC address of the user terminal 400. The content of the relay/discard flag field 630 in this entry represents “discard”. Therefore, the MAC address processing unit 530 discards the packet. In this manner, access to the file server 300 from the user terminal 400 that is not user-authenticated is rejected.

User authentication will now be described.

The user terminal 400 sends an authentication request packet having the MAC address of the authentication server 200 as its destination (S203). The filtering processing unit 132 of the network node 100 receives this authentication request packet via the network interface unit b 122. The MAC address processing unit 520 of the filtering processing unit 132 judges whether to relay or discard the packet with reference to the filtering table 520, as described above. The entries having a destination MAC address coincident with the MAC address of the authentication server 200 and having a source MAC address coincident with the MAC address of the user terminal 400 are the entries #1 and #4. Therefore, the MAC address processing unit 530 refers to the entry #1 and sends the packet to the IPv6 address processing unit 540 (S205).

Having received the packet, the IPv6 address processing unit 540 judges whether to relay or discard the packet with reference to the filtering table 520, as described above. The entries having a destination MAC address coincident with the MAC address of the authentication server 200 and a source IPV6 address coincident with the IPv6 address of the user terminal 400 are the entries #1 and #4. Therefore, the IPv6 address processing unit 540 refers to the entry #1 and sends the packet to the packet relay unit 110.

As the packet relay unit 110 receives the packet, the packet relay unit 110 refers to the address table 160 and searches the address table 160 to find whether an entry having the coincident source MAC address exists or not. Since the MAC address of the user terminal 400 already exists in the address table 160 as shown in FIG. 15, the processing shifts to the next step.

Next, the packet relay unit 110 refers to the address table 160 on the basis of the destination MAC address “22:22:00:11:11:11”and acquires “c” as the destination of relay. In accordance with the destination of relay “c”, the packet relay unit 110 relays the authentication request packet to the authentication server 200 via the network interface unit c 123 (S207). In this manner, the packet designated to be relayed by the filtering table 520 is relayed in accordance with the destination address.

Having received the authentication request packet, the authentication server 200 sends a request packet for a necessary authentication parameter for user authentication, using the MAC address of the user terminal 400 as the destination MAC address (S209).

The packet sent from the authentication server 200 is sent to the filtering processing unit 133 via the network interface unit c 123. The MAC address processing unit 530 of the filtering processing unit 133, which has received the packet, refers to the filtering table 520. Since nothing is has been registered in the filtering table 520 of the filtering processing unit 132, the MAC address processing unit 530 sends the packet to the IPv6 address processing unit 540 (S211). The IPv6 address processing unit 540 similarly sends the packet to the packet relay unit 110. As described above, the packet relay unit 110 refers to the address table 160 and acquires “b” as the destination of relay corresponding to the MAC address of the user terminal 400, which is the destination. The packet relay unit 110 relays the packet to the user terminal 400 via the network interface unit b 122 (S213).

Having received the request packet for an authentication parameter, the user terminal 400 sends a packet containing the requested authentication parameter, addressed to the authentication server 200 (S215). The authentication parameter is, for example, one of user ID, password, MAC address, IPv6 interface ID (referred to as IPv6-if ID in FIG. 16), IPv6 address and the like, or a combination of these.

The filtering processing unit 132 of the network node 100 receives the packet addressed to the authentication server 200 via the network interface unit b 122. The MAC address processing unit 530 and the IPv6 address processing unit 540 of the filtering processing unit 132 perform processing similar to the processing to relay the authentication request packet at steps S205 and S207, and thus relay the packet to the authentication server 200 from the network interface unit c 123 (S217, S219).

As the authentication server 200 receives the packet containing the authentication parameter, the authentication server 200 compares the received authentication parameter with authentication data stored in advance and thus performs user authentication. Using the MAC address and IPv6 interface ID in addition to the user ID and password as the parameter for user authentication improves the accuracy of user authentication. As user authentication is done, the authentication server 200 communicates with the filter change instruction processing unit 140 of the network node 100 and sends a status change instruction (S221). The status change instruction includes, for example, “arbitrary” as the destination address, the MAC address “22:22:FF:00:00:01” and IPv6 address “2001:200:0:1:2222:FFFF:FE00:1” of the user terminal 400 authenticated as the source address, a flag representing “relay”, and a flag indicating addition of an entry.

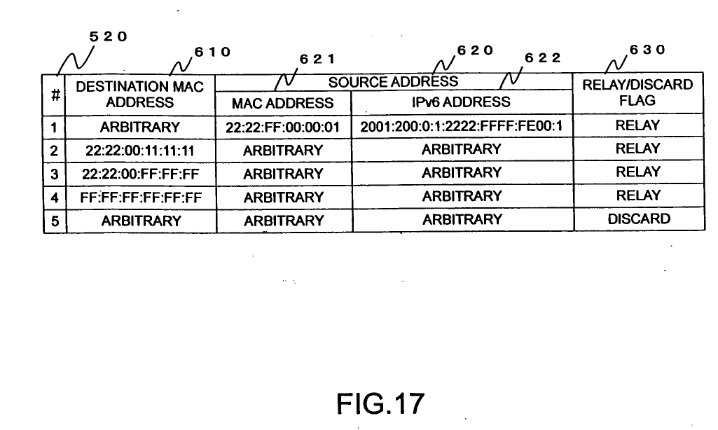

FIG. 17 shows a structural view of the filtering table 520 changed in accordance with the status change instruction. Having received the status change instruction from the authentication server 200, the filter change instruction processing unit 140 refers to the address table 160 on the basis of the MAC address of the user terminal 400 included in the status change instruction and acquires the identifier “b” of the network interface unit corresponding to the MAC address. Next, since the acquired identifier is “b”, the filter change instruction processing unit 140 changes the filtering table 520 of the filtering processing unit 132 corresponding to the network interface unit b 122 in accordance with the status change instruction. As shown in FIG. 17, an entry in which information included in the status change instruction is registered is newly added as entry #1. As this entry is added, a packet from the user terminal 400 to a device connected to the network node 100 of the file server 300 or the like is relayed.

The authentication server 200 may send a packet containing a status change instruction addressed to the network node 100, and the packet relay unit 110 may judge whether the received packet contains a status change instruction or not and then relay the packet. For example, if a packet addressed to the MAC address of the network node itself contains a status change instruction, the received packet maybe relayed to the filter change instruction processing unit 140, whereas if the packet contains a router request command, the received packet may be relayed to the IPv6 processing unit 150.

After the user authentication is completed, the user terminal 400 sends a packet (for example, a file reading request) having the MAC address of the file server 300 as its destination (S223).

The filtering processing unit 132 of the network node 100 receives the packet via the network interface unit b 122 and judges whether to relay or discard the packet. The entry #1 having both the source MAC address and source IPv6 address of the packet registered there in exists in the filtering table 520. Therefore, the MAC address processing unit 530 of the filtering processing unit 132 relays the packet to the IPv6 address processing unit 540 (S225), and the IPv6 address processing unit 540 relays the packet to the packet relay unit 110.

The packet relay unit 110 refers to the address table 160 and searches the address table 160 to find whether an entry having the coincident source MAC address exists or not. Since the entry having the MAC address of the user terminal 400 registered therein exists already in the address table 160, the processing shifts to the next step. The packet relay unit 110 refers to the address table 160 on the basis of the destination MAC address of the packet and acquires “d” as the destination of relay. In accordance with the acquired destination of relay, the packet relay unit 110 relays the packet to the file server 300 via the network interface unit d 124 (S227).

The file server 300 transmits the requested data addressed to the user terminal 400 (S229). The transmitted data is sent to the filtering processing unit 134 of the network node 100. The filtering processing unit 134 performs processing similar to the processing of steps S211 and S213 and thus relays the data to the user terminal 400 (S231, S233).

If an unauthorized user terminal spoofing as having the same IPv6 address has sent a packet to the file server 300, the packet is discarded by MAC filtering at the MAC address processing unit 530 (S251).

The filtering processing unit 132 performs filtering stage by stage, using the MAC address processing unit 530 and the IPv6 address processing unit 540. However, the filtering processing unit 132 can also perform MAC filtering and IP filtering simultaneously or perform these two kinds of filtering in batch processing. While the filtering processing unit 132 performs filtering by MAC address and IPv6 address, it can also perform filtering by IPv6 interface ID, using the filtering table 520 as shown in FIG. 9.

Not only when the user terminal 400 on the site D accesses the file server 300 on the site A but also when the user terminal belonging to one of the sites accesses to the file server on another site, processing similar to the processing shown in FIG. 16 is performed.

IPv6 address can also be used as destination address. In this case, IPv6 address and the identifier of the network interface unit are associated with each other and thus registered in the address table 160.

Moreover, the same IP address can be given to the authentication server 200 and the file server 300 so that these servers look like one server to the user terminal 400. That is, the user terminal 400 is to be user-authenticated by the authentication server 200, but after the authentication, the user terminal 400 accesses the fileserver 300 using the same IP address. Therefore, the network node 100 is provided with a measure to transfer a packet to the authentication server 200 before authentication and to transfer a packet to the file server 300 after authentication. For example, an address registration table for storing user-authenticated IP addresses is prepared.

3. Exemplary Application to Private Data Center

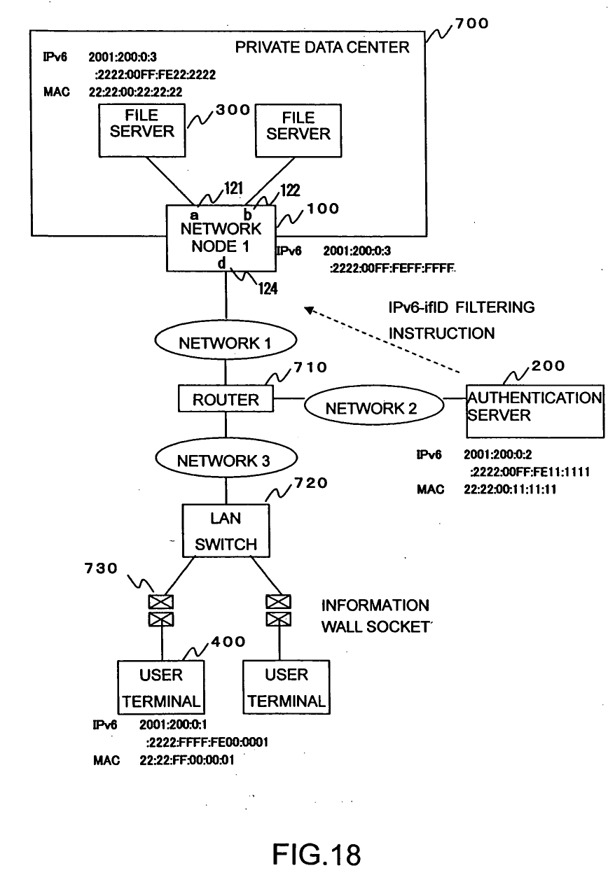

FIG. 18 shows a structural view in the case where the network authentication system is applied to a private data center.

In FIG. 18, a data center 700 is connected to a network 1, an authentication server 200 is connected a network 2, and user terminals 400 are connected to a network 3 via information wall sockets 730 and a LAN switch 720. The networks 1, 2 and 3 are connected with each other by a router 710. The data center 700 has a network node 100 and file servers (information servers) 300. The data center 700, the authentication server 200 and the user terminal 400 can communicate with each other via the networks 1, 2, 3 and the router 710. The user terminal 400 may be directly connected to the network 3 through the information wall socket 730.

The network node 100, the authentication server 200 and the file server 300 shown in FIG. 18 are equivalent to the authentication node 100, the authentication server 200 and the information server 300 shown in FIG. 1, respectively. The network node 100 has the structure shown in FIG. 2. In FIG. 18, the file servers 300 are connected to the network interface units a 121 and b 122, and the network 1 is connected to the network interface unit d 124.

The networks 1 to 3 are different IP subnets, which communicate with each other via the router 710. When a packet addressed to the data center 700 is sent from a user terminal 400, the MAC address of the user terminal 400 is deleted by the router 710 and does not reach the network node 100. Therefore, the network node 100 cannot perform the above-described MAC filtering. Moreover, the security strength against spoofing with IP address is low. Thus, the network node 100 filters the packet on the basis of interface ID of IPv6 address. Since the interface ID is ID proper to the device, it can improve the security strength.

The data center 700 includes servers collectively in one place and provides various kinds of services including web services to the user terminal 400. The servers maybe physically away from each other as long as they are logically collective. Only a single entrance/exit is provided between the servers and the network 1, and the network node 100 is arranged there to enable only a specific user terminal 400 to access the data center 700. As only the specific user terminal 400 is enabled to access the servers, the servers can be protected from DoS (denial of service) attacks. Moreover, as the network node 100 is provided with a measure for authentication, it is no longer necessary to provide a measure for authentication in each server.

In the following description, it is assumed that the IPv6 address of the network node 100 is “2001:200:0:3:2222:00FF:FEFF:FFFF”, the MAC address of the authentication server is “22:22:00:11:11:11”, its IPv6 address is “2001:200:0:2:2222:00FF:FE11:1111”, the MAC address of the file server 300 is “22:22:00:22:22:22”, and its IPv6 address is “2001:200:0:3:2222:00FF:FE22:2222”. It is also assumed that the MAC address of the user terminal 400 is “22:22:FF:00:00:01”.

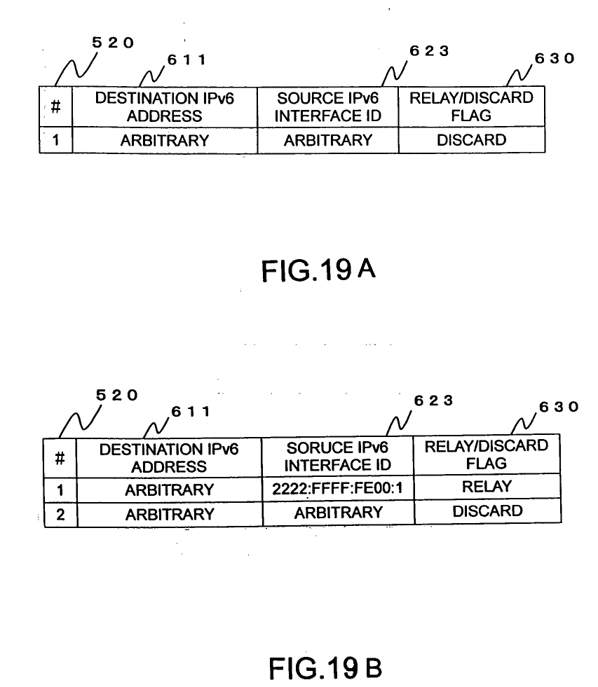

FIGS. 19A and 19B show an exemplary structure (3) of the filtering table 520. This filtering table 520 includes the destination IPv6 address field 611, the source IPv6 interface ID field 623 and the relay/discard flag field 630 for each entry. The filtering table 520 in which an entry #1 has been registered as shown in FIG. 19A is held in the filtering processing unit 134 on the network 1 side of the network node 100. Nothing is registered in the filtering tables of the filtering processing units 131 and 132 on the file server 300 side of the network node 100.

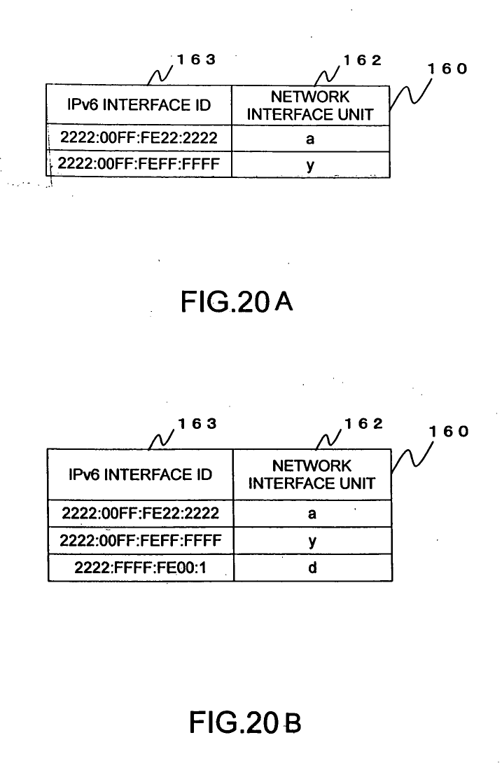

FIGS. 20A and 20B show an exemplary structure (2) of the address table 160. The address table 160 includes an IPv6 interface ID field 163 and the network interface unit field 162 for each entry. As shown in FIG. 20A, the IPv6 interface IDs of the file server 300 and the network node 100 itself have been registered in the address table 160 in advance.

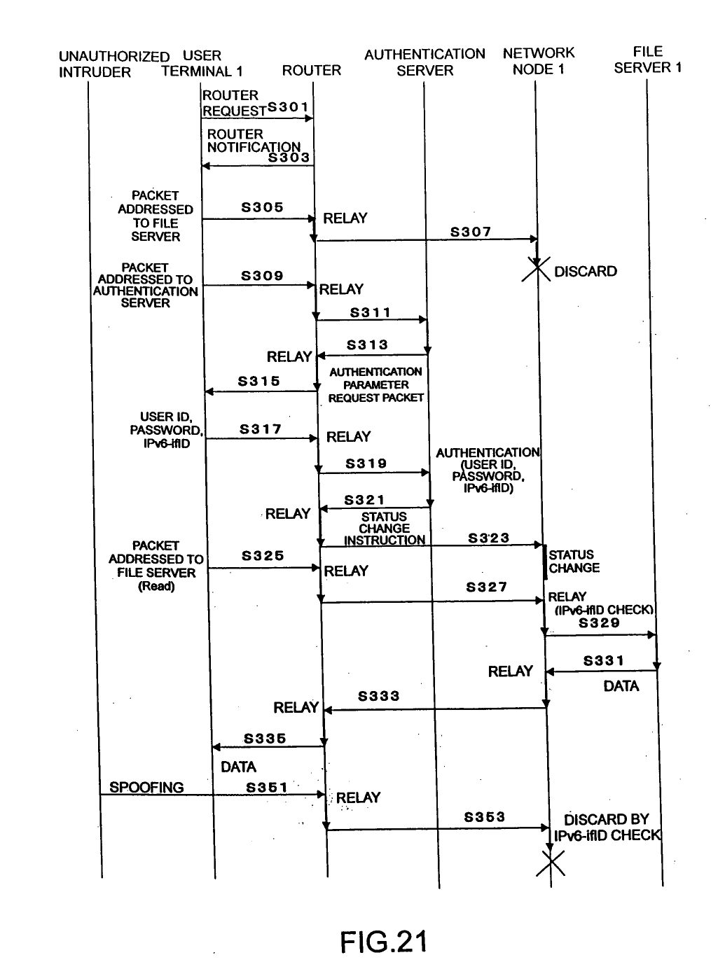

FIG. 21 shows a sequence in the case where the user terminal 400 accesses the file server 300 in the data center 700.

When the user terminal 400 is connected to the network 3 via the information wall socket 730, the user terminal 400 sends a router request command to the router 710 in order to acquire network ID (S301). The user terminal 400 may send the router request command having a broadcast address as its destination. Having received the router request command from the user terminal 400, the router 710 notifies the user terminal 400 of network ID, using a router notification command (S303). The user terminal 400 receives the network ID and prepares an IPv6 address based on the received network ID and its own MAC address.

Next, when a packet having the IPv6 address of the file server 300 as its destination IP address is sent from the user terminal 400 (S305), the router 710 receives this packet and routes it to the network 1 to which the file server 300 belongs (S307). At this point, the MAC address of the user terminal 400 included in the packet is deleted by the router 710.

The filtering processing unit 134 of the network node 100 receives the packet addressed to the fileserver 300 via the network interface unit d 124. The filtering processing unit 134 extracts the destination IPv6 address and the interface ID of the source IPv6 address from the received packet. Next, the filtering processing unit 134 refers to the filtering table 520 shown in FIG. 19A on the basis of the extracted destination IPv6 address and source IPv6 interface ID and judges whether to relay or discard the packet. Only the entry #1 has a destination IPv6 address coincident with the IPv6 address of the file server 300 and has source IPv6 interface ID coincident with the interface ID of the IPv6 address of the user terminal 400. Then, the content of the relay/discard flag field 630 of the entry #1 represents “discard”. Therefore, the filtering processing unit 134 determines to discard the packet and then discards the packet. In this manner, access from the user terminal 400 that is not user-authenticated is rejected.

Next, the user terminal 400 sends an authentication request packet having the IPv6 address of the authentication server 200 as its destination (S309). The router 710 receives the authentication request packet via the network 3 and routes the authentication request packet to the network 2 on the basis of the destination IPv6 address (S311).

As the authentication server 200 receives the authentication request packet via the network 2, the authentication server 200 sends a request packet for a necessary authentication parameter for user authentication, using the IPv6 address of the user terminal 400 as its destination (S313). The router 710 receives the request packet for an authentication parameter and routes the received packet to the network 3 on the basis of the destination IPv6 address (S315).

Having received the request packet for an authentication parameter via the network 3, the user terminal 400 sends a packet containing the requested authentication parameter addressed to the authentication server 200 (S317).

The authentication server 200 receives the packet containing the authentication parameter sent from the user terminal 400, via the router 710 (S319). Next, the authentication server 200 compares the received authentication parameter with authentication data stored in advance and thus performs user authentication. As the user authentication is done, the authentication server 200 communicates with the filter change instruction processing unit 140 of the network node 100 and sends a status change instruction to the filter change instruction processing unit 140 (S321). The status change instruction includes, for example, “arbitrary” as the destination address, the IPv6 interface ID “2222:FFFF:FE00:1” of the authenticated user terminal 400 as the source interface ID, a flag representing “relay”, and a flag indicating addition of an entry. The status change instruction is relayed from the network 2 to the network 1 by the router 710.

The filter change instruction processing unit 140 of the network node 100 receives the status change instruction sent from the authentication server 200 via the network interface unit d 124 (S323)

Having received the status change instruction, the filter change instruction processing unit 140 changes the filtering table 520 of the filtering processing unit 132 corresponding to the network interface unit d 124 connected with the network 1, in accordance with the status change instruction. As shown in FIG. 19B, an entry in which information included in the status change instruction is registered is newly added as an entry #1.

After the user authentication is completed, the user terminal 400 sends a packet (for example, file reading request) having the IPv6 address of the file server 300 as its destination (S325). The router 710 receives the packet from the network 3 and relays the packet to the network 1 on the basis of the destination IPv6 address (S327).

The filtering processing unit 134 of the network node 100 receives the packet addressed to the file server 300 via the network interface unit d 124. Next, the filtering processing unit 134 refers to the filtering table 520 on the basis of the destination IPv6 address and source IPv6 interface ID of the received packet as described above and judges whether to relay or discard the packet. Since the destination IPv6 address and source IPv6 interface ID of the packet match with the contents of the entries #1 and #3 of the filtering table as shown in FIG. 19B, the filtering processing unit 134 refers to the relay/discard flag field 630 of the entry #1 existing at a higher order on the table and sends the received packet to the packet relay unit 110.

As the packet relay unit 110 receives the packet from the filtering processing unit 134, the packet relay unit 110 refers to the address table 160 and searches the address table 160 to find whether an entry having the coincident source IPv6 interface ID exists or not. In the address table 160 shown in FIG. 20A, there is no entry having IPv6 interface ID coincident with the IPv6 interface ID of the user terminal 400, which is the source. Therefore, the packet relay unit 110 adds an entry containing the IPv6 interface ID of the user terminal 400 and the identifier “d” of the network interface unit d 124 connected to the network 1, as shown in FIG. 20B.

Next, the packet relay unit 110 refers to the address table 160 on the basis of the destination IPv6 interface ID of the received packet and acquires “a” as the destination of relay. In accordance with this, the packet relay unit 110 relays the packet to the file server 300 via the network interface unit a 121 (S329).

The file server 300 sends a packet containing requested data and having the IPv6 address of the user terminal 400 as its destination (S331).

The packet sent from the file server 300 is sent to the filtering processing unit 131 via the network interface unit a 121. Having received the packet, the filtering processing unit 131 refers to the filtering table 520. Since nothing is registered in the filtering table 520 of the filtering processing unit 131, the filtering processing unit 131 sends the packet to the packet relay unit 110.

The packet relay unit 110 refers to the address table 160 on the basis of the destination IPv6 interface ID and acquires “d” as the destination of relay, as described above. In accordance with the acquired destination of relay “d”, the packet relay unit sends the packet to the user terminal 400 via the network interface unit d 124 (S333). The packet is relayed from the network 1 to the network 3 by the router 710. The user terminal 400 receives the packet via the LAN switch 720 and the information wall socket 730 (S335). If the user terminal 400 is user-authenticated once, it can access the other file servers in the private data center 700.

If an unauthorized user terminal (intruder) attempts to access the file server 300 (S351), a packet from the unauthorized user terminal is relayed by the router 710 (S353). At this point, the source MAC address of the packet is deleted by the router 710. However, as the filtering processing unit 134 of the network node 100 receives this packet, it discards the packet by filtering based on IPv6 interface ID.

As access from the unauthorized user terminal is rejected in this manner, the file servers 300 can be protected from DoS attacks. The server itself need not have a measure for authentication and can be easily managed.

4. Exemplary Application to Internet VPN

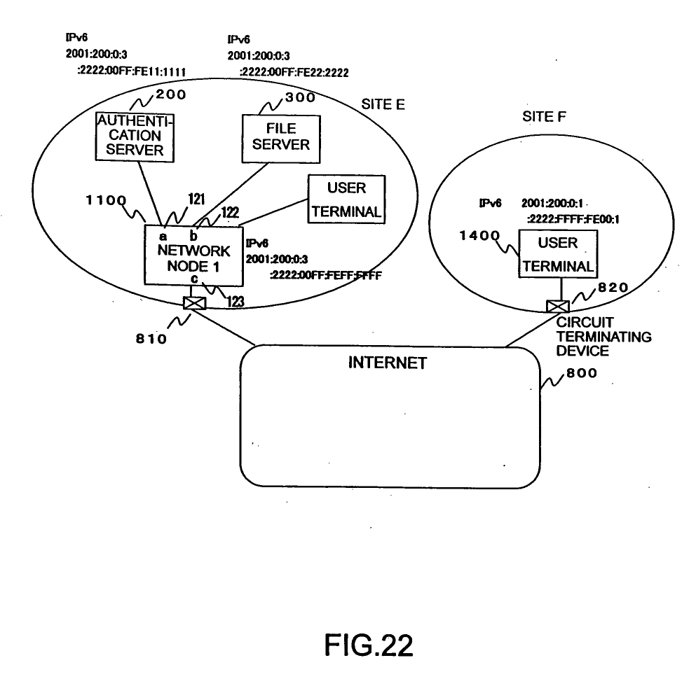

FIG. 22 shows a structure view in the case where the network authentication system is applied to an Internet VPN.

In FIG. 22, a site E and a site Fare connected to the Internet 800 via circuit terminating devices 810 and 820, respectively. The site E has a network node 1100 capable of IPsec (security architecture for the Internet Protocol) communication, an authentication server 200, and a file server 300. The site F has a user terminal 1400 capable of IPsec communication.

FIG. 22 shows an example in which a corporation or the like constructs an in-house intranet using an Internet connection service provided by a communication service provider. Each site performs communication, for example, using a tunneling technique with IPsec. This enables each site to perform communication in such a manner as if the sites were connected with each other via leased lines. At each site, packets are encrypted and then transmitted/received.

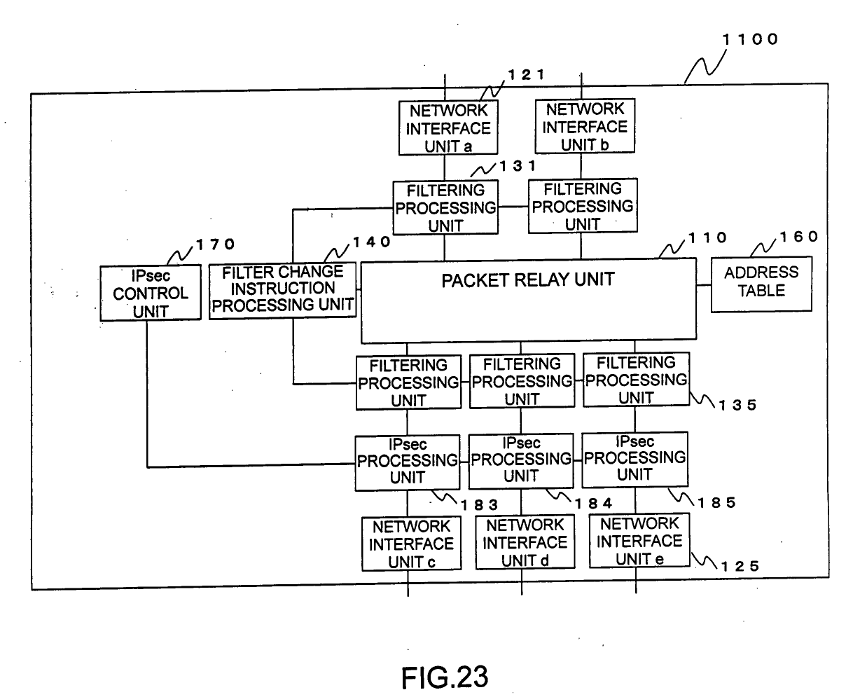

FIG. 23 shows a structural view of the network node 1100 capable of IPsec communication. The network node 1100 is equivalent to the network node 100 shown in FIG. 2. Like the network node 100, the network node 1100 has the packet relay unit 110, the network interface units a 121 to e 125, the filtering processing units 131 to 135, the filter change instruction processing unit 140, and the address table 160. It also has an IPsec control unit 170 and IPsec processing units 183 to 185. The IPsec processing units may be provided corresponding to at least the network interface units connected to the Internet 800. For example, the network node 1100 shown in FIG. 23 has the IPsec processing units 183 to 185 corresponding to the network interface units 123 to 125. Alternatively, the IPsec processing units may be provided corresponding to all the network interface units.

The IPsec control unit 170 mainly performs key exchange using an IKE (Internet key exchange) protocol with each communication counterpart. The IPsec control unit 170 prepares a private symmetric key to the user terminal 1400 and automatically generates a communication path (SA or security association) on the Internet 800. The network node 1100 and the user terminal 1400 transmit and receive packets via the SA generated by the IPsec control unit 170. The IPsec control unit 170 has a key table in which a private symmetric key, a pre-shared key, a public key and the like a restored for each user terminal. The pre-shared key is the same key (password) stored in advance in the IPsec control unit 170 and the user terminal 1400.

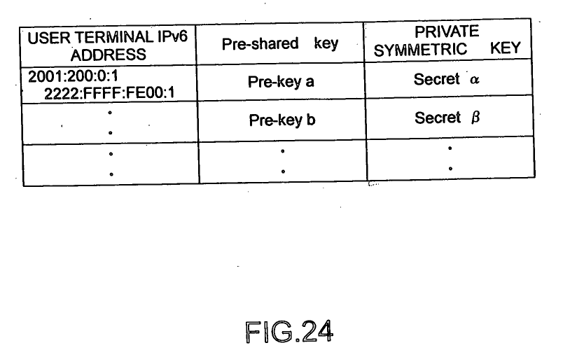

FIG. 24 shows an exemplary structure of the key table. For example, the key table contains a user terminal IPv6 address field, a predetermined pre-shared key field, and a private symmetric key field prepared when generating the communication path.

The IPsec processing units 183 to 185 mainly perform encryption/decoding of data (ESP or encapsulating security payload) and packet authentication (AH or authentication header) to confirm whether a packet is falsified or not. The IPsec processing units 183 to 185 also perform authentication of a communication counterpart using the pre-shared key or the like stored in the IPsec control unit 170.

The user terminal 1400 is a terminal capable of IPsec communication. It forms an SA to the network node 1100 and communicates via the SA.

The authentication server 200 and the file server (information server) 300 connected to the network interface units a 121 and b 122 of the network node 1100, respectively, are identical to the authentication server 200 and the information server 300 shown in FIG. 1.

In the following description, it is assumed that the IPv6 address of the network node 1100 is “2001:200:0:3:2222:00FF:FEFF:FFFF”, the IPv6 address of the authentication server is “2001:200:0:3:2222:00FF:FE11:1111”, and the IPv6 address of the file server 300 is “2001:200:0:3:2222:00FF:FE22:2222”.

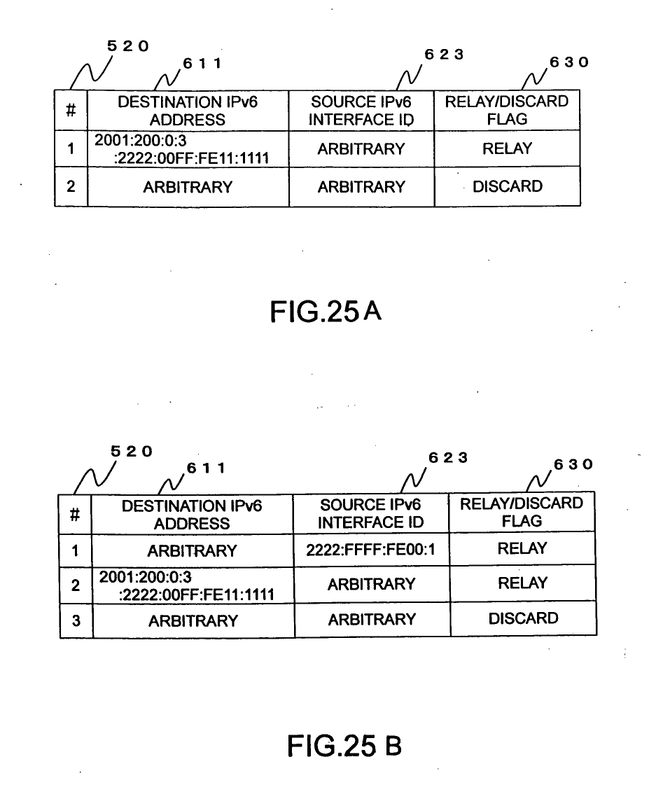

FIGS. 25A and 25B show an exemplary structure (4) of the filtering table 520. For example, the filtering table 520 shown in FIG. 25A is registered in the filtering processing unit 133 corresponding to the network interface unit 123 connected to the Internet 800. As shown in FIG. 25A, entries #1 and #2 have been registered in advance in the filtering table 520. In the entry #1, the IPv6 address of the authentication server and information representing “relay” have been registered.

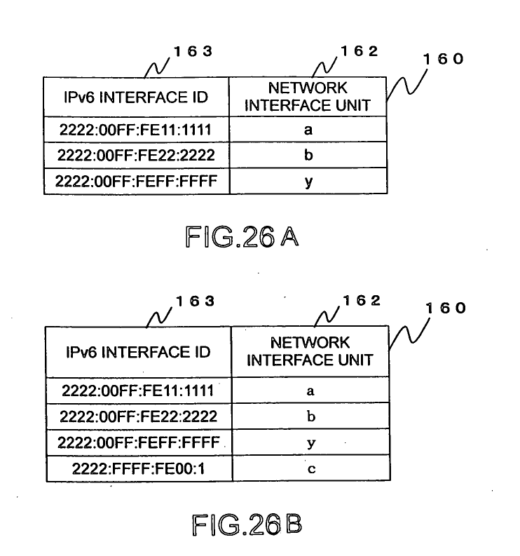

FIGS. 26A and 26B show an exemplary structure (3) of the address table 160. For example, the IPv6 interface IDs of the authentication server 200, the file server 300 and the network node 1100 itself have been registered in the address table 160.

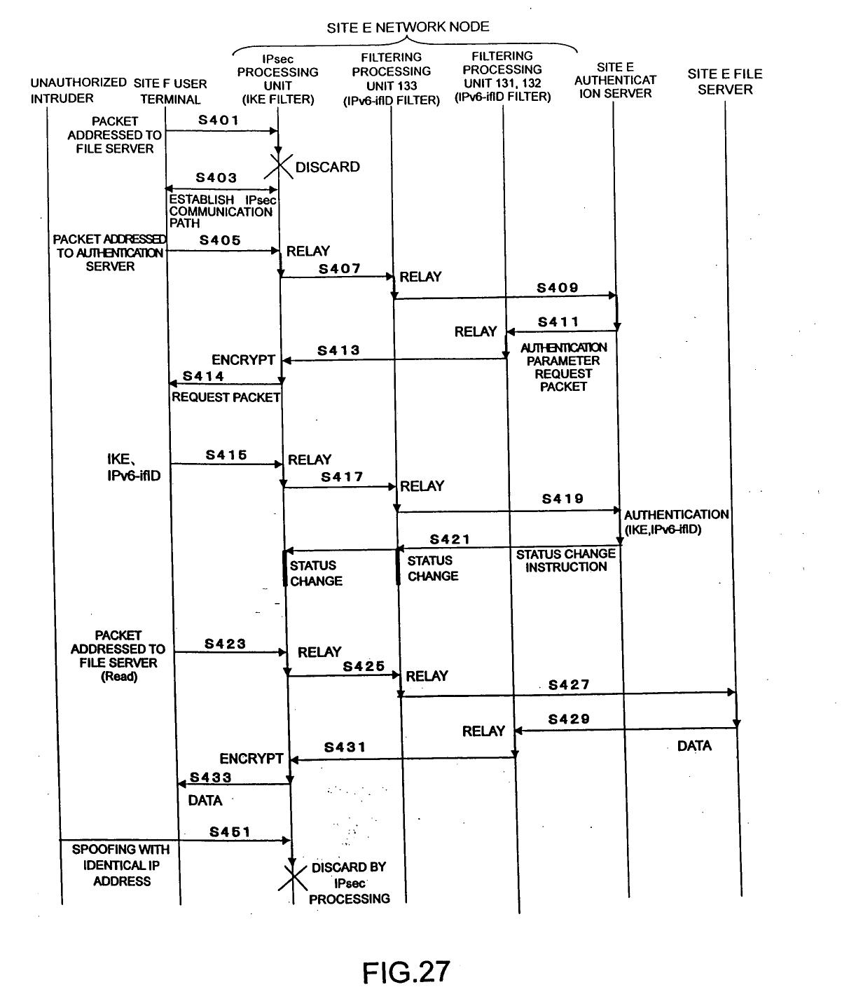

FIG. 27 shows a sequence in the case where the user terminal 1400 on the site F accesses the file server 300 on the site E.

For example, the user terminal 1400 sends a packet addressed to the file server without using IPsec (S401). The network interface unit c 123 of the network node 1100 on the site E receives the packet via the Internet 800 and sends the packet to the IPsec processing unit 183. The IPsec processing unit 183 refers to the pre-shared key, public key and the like stored in the IPsec control unit 170 and performs, for example, pre-shared key authentication, public key encryption authentication, digital signature authentication or the like. The packet received from the user terminal 1400 has not been IPsec-processed. Therefore, the packet is not authenticated and the IPsec processing unit 183 discards the packet.

An example of authentication using a pre-shared key based on the IKE protocol will now be described. The user terminal 1400 calculates an authentication value on the basis of the pre-shared key stored in advance and its own ID information (for example, IPv6 address) and sends a packet containing the authentication value. Having received the packet, the IPsec processing unit 183 acquires a pre-shared key from the key table in the IPsec control unit 170 on the basis of the source IPv6 address of the received packet (or address of IPsec communication device). The IPsec processing unit 183 performs predetermined calculation based on the acquired pre-shared key and the source IPv6 address and compares the result of the calculation with the authentication value sent from the user terminal 1400. If the user terminal 1400 does not use the pre-shared key corresponding to the IPv6 address, for example, if the user terminal 1400 does not know the pre-shared key, the values do not match with each other as a result of the comparison. If the values match with each other as a result of the comparison, the IPsec processing unit 183 sends the packet to the filtering processing unit 133. On the other hand, if the values do not match with each other as a result of the comparison, the IPsec processing unit 183 discards the packet.

Next, processing for the user terminal 1400 to access the file server 300 will be described. First, the user terminal 1400 establishes an IPsec communication path to the network node 1100 (S403).

For example, the user terminal 1400 sends a request packet for generation of a control channel ISAKMP (Internet security association and key management protocol) SA to the network node 1100. The IPsec processing unit 183 of the network node 1100 receives the request packet via the network interface unit 123 and sends it to the IPsec control unit 170. The IPsec control unit 170 refers to a security policy table or the like in which the source of the request packet and information representing acceptance/rejection of communication have been registered in advance. If the IPsec control unit 170 determines to accept communication, it sends an acceptance notification to the user terminal 1400. Next, the user terminal 1400 and the IPsec control unit 170 perform generation of a private symmetric key and authentication (for example, pre-shared key authentication) with respect to whether the counterpart is the target party of communication acceptance, and generate an ISAKMP SA. Moreover, the user terminal 1400 and the IPsec control unit 170 communicate with each other via the ISAKMP SA, then generates a private symmetric key, and generates an SA for actual transmission/reception of packets. The IPsec control unit 170 stores the generated private symmetric key for each user terminal 1400. By the above-described processing, the IPsec communication path is established between the user terminal 1400 and the network node 1100.

Next, the user terminal 1400 sends an authentication request packet having the IPv6 address of the authentication server 200 as its destination (S405). A packet from the user terminal 1400 having the network ID of the site E as its destination is encrypted with the private symmetric key generated at the time of establishing the communication path by the ESP function, and is sent via the IPsec communication path.

The network interface unit 123 of the network node 1100 receives the authentication request packet via the IPsec communication path and sends it to the IPsec processing unit 183. Having received the packet, the IPsec processing unit 183 acquires a private symmetric key from the key table in the IPsec control unit 170 on the basis of the source IPv6 address of the packet (or address of IPsec communication device). The IPsec processing unit 183 decodes the packet by the ESP function using the acquired private symmetric key. Next, the IPsec processing unit 183 performs authentication of the communication counterpart in accordance with the IKE, protocol. For example, the IPsec processing unit 183 performs authentication using the above-described pre-shared key. As the communication counterpart is authenticated, the IPsec processing unit 183 sends the authentication request packet to the filtering processing unit 133 (S407).

Having received the packet, the filtering processing unit 133 refers to the filtering table 520 shown in FIG. 25A on the basis of the destination IPv6 address and source IPv6 interface ID of the packet and judges whether to relay or discard the packet. The authentication request packet contains the IPv6 address of the authentication server as its destination and contains the IPv6 interface ID of the user terminal 1400 as its source IPv6 interface ID. These address and interface ID match with the contents of the entries #1 and #2. Therefore, the filtering processing unit 133 sends the packet to the packet relay unit 110 in accordance with the content of the relay/discard flag field of the entry #1, which is of a higher order.

The packet relay unit 110 extracts the source IPv6 interface ID of the received packet and searches the address table 160 to find whether an entry including the extracted source IPv6 interface ID exists or not. The address table 160 contains no entry including the IPv6 interface ID of the user terminal 1400, which is the source. Therefore, the packet relay unit 110 adds an entry including the IPv6 interface ID of the user terminal 1400 and the identifier “c” corresponding to the network interface unit 123 which has received the packet. FIG. 26B shows the address table 160 in which the entry has been added.

The packet relay unit 110 also extracts the destination IPv6 interface ID from the received packet, then refers to the address table 160 on the basis of the extracted destination IPv6 interface ID, and acquires the identifier “a” of the network interface unit, which is the destination of relay. In accordance with this, the packet relay unit 110 sends the received packet to the authentication server 200 from the network interface unit a 121 (S409).

Having received the authentication request packet, the authentication server 200 sends an authentication parameter request packet having the IPv6 address of the user terminal 1400 as its destination (S411).

The network interface unit a 121 receives the authentication parameter request packet from the authentication server 200 and sends it to the filtering processing unit 131. Since nothing has been registered in the filtering table 520 of the filtering processing unit 131, the filtering processing unit 131 sends the packet to the packet relay unit 110.

The packet relay unit 110 refers to the address table 160 and acquires the destination of relay “c” on the basis of the destination IPv6 interface ID of the packet, as described above. The packet relay unit 110 relays the packet to the IPsec processing unit 183 corresponding to the network interface unit c 123 (S413). The IPsec processing unit 183 acquires a private symmetric key corresponding to the destination IPv6 address of the packet from the IPsec control unit 170 and encrypts the packet by the ESP function using the private symmetric key. The IPsec processing unit 183 sends the encrypted packet to the user terminal 1400 via the network interface unit c 123 (S414).

As the user terminal 1400 receives the authentication parameter request packet, the user terminal 1400 sends a packet containing IKE authentication information and IPv6 interface ID to the authentication server 200 (S415). The IKE authentication information can be, for example, a value found by predetermined calculation using the pre-shared key. By processing similar to the processing of steps S407 and S409, the IPsec processing unit 183 and the filtering processing unit 133 of the network node 1100 relay the packet from the user terminal 1400 to the authentication server 200 (S417, S419).

As the authentication server 200 receives the packet containing the IKE authentication information and IPv6 interface ID, the authentication server 200 compares these with information stored in advance and thus performs user authentication. As the user authentication is done, the authentication server 200 communicates with the filter change instruction processing unit 140 of the network node 1100 and sends a status change instruction to the filter change instruction processing unit 140 (S421). The status change instruction includes, for example, “arbitrary” as the destination IPv6 address, the IPv6 interface ID of the user terminal 1400 as the source IPv6 interface ID, a flag representing “relay”, and information indicating addition of an entry.

Having received the status change instruction from the authentication server 200, the filter change instruction processing unit 140 refers to the address table 160 on the basis of the source IPv6 interface ID included in the status change instruction. The filter change instruction processing unit 140 acquires the identifier “c” of the network interface unit. The filter change instruction processing unit 140 changes the content of the filtering table of the filtering processing unit 133 corresponding to the acquired identifier “c”, in accordance with the status change instruction. FIG. 25B shows a structural view of the filtering table in which an entry #1 has been newly added. This enables communication between the user-authenticated user terminal 1400 and the file server 300 on the site E.

Next, the user terminal 1400 sends a packet (for example, file reading request) having the IPv6 address of the file server 300 as its destination (S423). The IPsec processing unit 183 of the network node 1100 receives the packet from the user terminal 1400 and sends it to the filtering processing unit 133, as described above (S425). The filtering processing unit 133 sends the packet received from the IPsec processing unit 183 to the packet relay unit 110, as described above.

The packet relay unit 110 refers to the address table on the basis of the destination IPv6 interface ID and acquires “b” as the destination of relay. The packet relay unit 110 sends the packet to the file server 300 via the network interface unit 122 (S427).

Having received the packet, the file server 300 sends a packet containing requested data addressed to the user terminal 1400 (S429). The network interface unit b 122 receives the packet from the file server 300 and sends it to the filtering processing unit 132. Similar to steps S413 and S414, the filtering processing unit 132 sends the received packet to the packet relay unit 110, and the packet relay unit 110 sends it to the IPsec processing unit 183 (S431). The IPsec processing unit 183 encrypts the packet by the ESP function using the private symmetric key and sends the packet via the network interface unit c 123 (S433). The user terminal 1400 receives the packet from the file server 300 and decodes the packet by the ESP function using the private symmetric key. The user terminal 1400 can thus acquires the data.

It is now assumed that an unauthorized intruder spoofing as the same IPv6 address as the user terminal 1400 has sent a packet to the file server 300 or the like (S451). However, the terminal of the unauthorized intruder does not share the pre-shared key and public key with the network node 1100. Therefore, having received the packet from the terminal of the unauthorized intruder, the IPsec processing unit 183 cannot authenticate the communication counterpart in accordance with the IKE protocol and therefore discards the packet.

The parameters of the above-described authentication and filtering are not limited to the above-described examples.

What is claimed is:

1. A network authentication apparatus comprising:
a network interface unit connected with a network and transmitting/receiving a packet;
a packet relay unit for relaying a received packet in accordance with a destination address of the received packet; and
a filtering processing unit for judging whether to relay the received packet to the packet relay unit or discard the packet in accordance with two or more of a destination MAC address, destination IPv6 address, source MAC address, source IPv6 address and source IPv6 interface ID contained in the received packet.

2. The network authentication apparatus as claimed in claim 1,
wherein the filtering processing unit judges whether to relay the received packet to the packet relay unit or discard the packet in accordance with at least the destination MAC address, and, source IPv6 address or source IPv6 interface ID.

3. The network authentication apparatus as claimed in claim 1,
wherein the filtering processing unit further comprises:
a filtering information storage unit for storing at least a destination MAC address, and, source MAC address or source IPv6 address or source IPv6 interface ID, and, judgment information representing relay or discard in association with each other; and
a processing unit for comparing the destination MAC address and source MAC address or source IPv6 address or source IPv6 interface ID contained in the received packet with the destination MAC address and source MAC address or source IPv6 address or source IPv6 interface ID stored in the filtering information storage unit, and when the addresses match with each other, judging whether to relay the received packet to the packet relay unit or discard the packet in accordance with the judgment information associated with each address.

4. The network authentication apparatus as claimed in claim 1,
wherein the filtering processing unit comprises:
a MAC filtering unit for judging whether to relay the received packet to the packet relay unit or discard the packet in accordance with the destination MAC address or source MAC address contained in the received packet; and
an IP filtering unit for judging whether to relay the received packet to the packet relay unit or discard the packet in accordance with the source IPv6 address or source IPv6 interface ID contained in the received packet.

5. The network authentication apparatus as claimed in claim 4,
wherein the filtering processing unit further comprises:
a filtering information storage unit for storing at least a destination MAC address, and, source MAC address or source IPv6 address or source IPv6 interface ID, and, judgment information representing relay or discard in association with each other.

6. The network authentication apparatus as claimed in claim 4,
wherein the MAC filtering unit further comprises:
a MAC filtering information storage unit for storing a destination MAC address and source MAC address and judgment information representing relay or discard in association with each other; and
the IP filtering unit further comprises:
an IP filtering information storage unit for storing a destination MAC address, and, source IPv6 address or source IPv6 interface ID, and, judgment information representing relay or discard in association with each other.

7. The network authentication apparatus as claimed in claim 6,
wherein the MAC filtering unit compares the destination MAC address or source MAC address contained in the received packet with the destination MAC address or source MAC address stored in the MAC filtering information storage unit, and when the addresses match with each other, judging whether to relay the received packet to the packet relay unit or discard the packet in accordance with the judgment information associated with the destination MAC address or source MAC address; and
the IP filtering unit compares the source IPv6 address or source IPv6 interface ID contained in the received packet with the source IPv6 address or source IPv6 interface ID stored in the IP filtering information storage unit, and when the addresses or interface IDs match with each other, judging whether to relay the received packet to the packet relay unit or discard the packet in accordance with the judgment information associated with the source IPv6 address or source IPv6 interface ID.

8. The network authentication apparatus as claimed in claim 1, further comprising:
an authentication unit for receiving an authentication request from an arbitrary information terminal device connected to the network interface unit via a network and executing authentication on the basis of predetermined information related to the arbitrary information terminal device.

9. The network authentication apparatus as claimed in claim 8,
wherein the authentication unit has an authentication information storage unit for storing user ID, password, and, IPv6 interface ID or MAC address in associated with each other, and performs authentication by comparing user ID, password, and, IPv6 interface ID or MAC address received from the arbitrary information terminal device with the user ID, password, and, IPv6 interface ID or MAC address stored in the authentication information storage unit.

10. The network authentication apparatus as claimed in claim 1, further comprising:
a security control unit for generating or exchanging a key for packet encryption or decoding for each communication counterpart, using a key exchange protocol; and
a security processing unit for executing authentication of at least the received packet, using the key generated by the security control unit.

11. A network authentication system comprising:
an authentication server for receiving an authentication request from an arbitrary information terminal device connected via a network and executing authentication on the basis of predetermined information related to the arbitrary information terminal device; and
a network node device connected to the network and relaying a packet received from the network;
wherein the network node device having:
a network interface unit connected with the network and transmitting/receiving a packet;
a packet relay unit for relaying a received packet in accordance with a destination address of the received packet; and
a filtering processing unit for judging whether to relay the received packet to the packet relay unit or discard the packet in accordance with two or more of a destination MAC address, destination IPv6 address, source MAC address, source IPv6 address and source IPv6 interface ID contained in the received packet;
and wherein the filtering processing unit relays only a packet addressed to the authentication server to the packet relay unit, of packets sent from an arbitrary information terminal device that is not authenticated by the authentication server.

12. The network authentication system as claimed in claim 11,
wherein the filtering processing unit of the network node device further comprises:
a filtering information storage unit for storing at least a destination MAC address, and, source MAC address or source IPv6 address or source IPv6 interface ID, and, judgment information representing relay or discard in association with each other; and
a processing unit for comparing the destination MAC address, and, source MAC address or source IPv6 address or source IPv6 interface ID contained in the received packet with the destination MAC address, and, source MAC address or source IPv6 address or source IPv6 interface ID stored in the filtering information storage unit, and when the addresses match with each other, judging whether to relay the received packet to the packet relay unit or discard the packet in accordance with the judgment information associated with each address.

13. The network authentication system as claimed in claim 12,
wherein the authentication server includes an instruction issuing unit for instruction addition of information of the arbitrary information terminal device when the arbitrary information terminal device is authenticated;
the network node device includes a change unit for newly registering the MAC address or IPv6 address or IPv6 interface ID of the arbitrary information terminal device as the source MAC address or the source IPv6 address or the source IPv6 interface ID into the filtering information storage unit together with the judgment information representing relay in accordance with an instruction from the authentication server; and
the filtering processing unit relays a packet sent from the arbitrary information terminal device authenticated by the authentication server, to the packet relay unit.

14. The network authentication system as claimed in claim
wherein the filtering processing unit of the network node device further comprises:
a MAC filtering unit for judging whether to relay the received packet to the packet relay unit or discard the packet in accordance with the destination MAC address or source MAC address contained in the received packet; and
an IP filtering unit for judging whether to relay the received packet to the packet relay unit or discard the packet in accordance with the source IPv6 address or source IPv6 interface ID contained in the received packet.

15. The network authentication system as claimed in claim 14,
wherein the filtering processing unit of the network node device further comprises:
a filtering information storage unit for storing at least a destination MAC address, source MAC address, source IPv6 address or source IPv6 interface ID in association with judgment information representing relay or discard;
the MAC filtering unit compares the destination MAC address or source MAC address contained in the received packet with the destination MAC address or source MAC address stored in the filtering information storage unit, and when the addresses match with each other, judging whether to relay the received packet to the packet relay unit or discard the packet in accordance with the judgment information associated with the destination MAC address or source MAC address, and
the IP filtering unit compares the source IPv6 address or source IPv6 interface ID contained in the received packet with the source IPv6 address or source IPv6 interface ID stored in the filtering information storage unit, and when the addresses or interface IDs match with each other, judging whether to relay the received packet to the packet relay unit or discard the packet in accordance with the judgment information associated with the source IPv6 address or source IPv6 interface ID.

16. A switch apparatus comprising:
plural network interface units connected with a network and transmitting/receiving packets;
a packet switch unit for relaying a received packet between the plural network interface units in accordance with a destination address of the received packet; and
a filtering processing unit for judging whether to relay a received packet to the packet switch unit or discard the packet in accordance with two or more of a destination MAC address, destination IPv6 address, source MAC address, source IPv6 address and source IPv6 interface ID contained in the received packet.
